(19) United States
(12) Patent Application Publication
(10) Pub. No.: US 2009/0258310 A1
(43) Pub. Date: Oct. 15, 2009

(54) PRODUCING METHOD OF SPHERICAL PARTICLE, SPHERICAL PARTICLE, TONER, DEVELOPER, DEVELOPING DEVICE AND IMAGE FORMING APPARATUS

(76) Inventors: Katsuru MATSUMOTO, Osaka (JP); Keiichi Kikawa, Osaka (JP); Ayae Nagaoka, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/421,043

(22) Filed: Apr. 9, 2009

(30) Foreign Application Priority Data
Apr. 9, 2008 (JP) P2008-101962

(51) Int. Cl. G03G 9/087; G03G 9/08; G03G 15/08

(52) U.S. Cl. 430/109.2; 430/110.3; 430/109.4; 430/109.1; 399/252

(57) ABSTRACT

There are provided an economical method capable of obtaining very small resin particles, in particular, resin particles; resin particles produced by the method; a toner and developer containing the resin particles; a developing device; and an image forming apparatus. Spherical particles are produced according to a producing method of spherical particles including a pulverizing step. In the pulverizing step, a dispersion liquid of coarse particles of material to be processed, which includes a polymer dispersant and coarse particles of material to be processed dispersed in a liquid medium is passed through a high-pressure homogenizer having a stepwise pressure release mechanism and thereby coarse particles of material to be processed contained in the dispersion liquid are milled under conditions where the melt viscosity of the dispersion liquid at a time point of passing the nozzle portion of the high-pressure homogenizer may be 5000 cP or less.

### CROSS-REFERENCE TO RELATED APPLICATION

This application claims priority to Japanese Patent Application No. 2008-101962, which was filed on Apr. 9, 2008, the contents of which are incorporated herein by reference in its entirety.

### BACKGROUND OF THE INVENTION

1. Field of the Invention

The present invention relates to a producing method of a spherical particle, a spherical particle, a toner, a developer, a developing device and an image forming apparatus.

2. Description of the Related Art

An image forming apparatus for electrophotographically forming images includes a photoreceptor, a charging section, an exposure section, a developing section, a transfer section, a fixing section, and a cleaning section, and with which a charging step, an exposure step, a development step, a transfer step, a fixing step, a cleaning step and a charge removing step are carried out to form an image on a recording medium.

In the charging step, a photoreceptor surface is uniformly charged with a charging section. In the exposure step, a charged photoreceptor is exposed with an exposure portion to form an electrostatic latent image on a surface of the photoreceptor. In the development step, the electrostatic latent image formed on a surface of the photoreceptor is developed with a developer to form a visible image.

Specifically, the toner charged at a developing section is attached to the electrostatic latent image formed on the photoreceptor surface to form a visible image on the photoreceptor surface. In the transfer step, a visible image formed on the photoreceptor surface is transferred by use of a transfer section on a recording medium such as paper. In the fixing step, the transferred visible image is fixed on the recording medium under heating and pressure, for example. In the cleaning step, transfer residue toner remaining on the photoreceptor surface after the transfer step is removed by use of a cleaning portion. In the charge removing step, charges on the photoreceptor surface are removed by use of a charge removing portion to prepare for next image formation.

Fine polymer particles used in a wet or dry electrophotographic developer composition that is used in an image forming apparatus like this are generally formed by milling or grinding for a longtime. In a milling step, polymer particles suspended in a non-soluble solution are milled under optional heating to form particles having a small particle size. However, when these methods are adopted, it is difficult to obtain, at low cost, dry particles having a small particle size and (substantially) free from milled medium or impurities from the apparatus on a surface of the particles. The particles formed by milling or grinding are generally larger than 2.0 μm in particle size and are not suitable for a wet or dry electrophotographic developer composition. Accordingly, generally, unless a long wearing time, e.g., generally a wearing time exceeding 6 hours is consumed to reduce the particle size to 2.0 μm order, the milled or ground particles are not suitable for, in particular, high quality color print application.

Accordingly, it is neither economically nor mechanically preferred to mill particles larger than 2.0 m in particle size to a size necessary for a wet or dry electrophotographic developer composition, that is, substantially 0.1 to 5 μm, in particular, to mill with fluid energy.

Furthermore, in a method where a polymer suspended in a solvent is spray dried to form particles, there are fears in that a particle size may become far larger than 1 μm, a particle size distribution may be widened owing to linear resin fibers or strands, or a ratio at which particles that are usable as the developer are trapped in a solvent may be low. Furthermore, in the methods, recovery of the solvent becomes very expensive.

In order to overcome such problems, a producing method of toner particles for use in wet electrophotographic image formation including (a) a step of mixing a thermoplastic resin and a nonpolar liquid at a temperature sufficiently high to plasticize and liquefy the thermoplastic resin and lower than a temperature at which the nonpolar liquid boils and the thermoplastic resin decomposes, (b) a step of cooling the mixture obtained in the step (a) to form resin particles containing the thermoplastic resin in the nonpolar liquid, and (c) a step of reducing the size of the resin particles to less than 30 μm by passing the product obtained in the step (b) through at least one liquid jet interaction chamber at liquid pressure of at least 1000 psi (68 bar), by use of, for example, a Microfluidizer (®, manufactured by Microfluidics) is disclosed in U.S. Pat. No. 4,783,389. According to the producing method of the toner particles for use in wet electrophotographic image formation disclosed in U.S. Pat. No. 4,783,389, a wet electrophotographic developer may be produced faster than existing methods.

Furthermore, a producing method of an electrophotographic developer that includes (a) a step of Forming a melt mixture containing a polymer resin, a colorant, a charge director and a water-insoluble medium to obtain a first suspension of color polymer particles having a volume average particle size from substantially 5 μm to substantially 100 μm and (b) a step of homogenizing the first suspension by use of a dairy piston homogenizer under pressure of substantially 100 bar to substantially 500 bar to obtain a second suspension containing color polymer particles having a volume average particle size from substantially 0.1 μm to substantially 5 μm is disclosed in Japanese Unexamined Patent Publication JP-A 7-064348 (1995).

However, according to the producing method disclosed in U.S. Pat. No. 4,783,389, the clogging of a jet nozzle caused by particles having a particle size larger than 50 μm is caused frequently and repeatedly.

Furthermore, process pressure of a typical microfluidizer is larger than 500 bar; accordingly, there is a fear in that the polymer suspension in the water-insoluble solvent is destabilized and thereby resin filaments and large particles unsuitable for wet and dry electrophotographic developers may be formed.

Still furthermore, in the producing method disclosed in U.S. Pat. No. 4,783,389, the particle size is reduced according to two principle mechanisms, that is, collisions of particles between two counter flows and cavitation, when the microfluidizer is used. However, when a liquid dispersion of very fine particles is produced, there are some intrinsic problems and operation limits in the use of the microfluidizer. For example, 1) a fluidized feed solution has to be heated to from substantially 80 to substantially 100° C. and initial particle size has to be less than 50 μm, 2) much energy is necessary for the microfluidizer device to obtain ultrasonic high pressure, 3) the clogging tends to occur; accordingly, periodical disassembly and long time cleaning are necessary, that is, a continuous operation is difficult, and 4) suspended resin particles are difficult or almost impossible to re-disperse, that is, the stability may be damaged when left at room temperature. Furthermore, under operation pressure exceeding 500 bar, that is, under typical microfluidizer process/operation pressure, resin filaments and large particles tend to be formed.

According to the producing method disclosed in JP-A 7-064348, in the step (b), discontinuous pressure release is applied; accordingly, a sharp particle size distribution may not be obtained.

### SUMMARY OF THE INVENTION

An object of the invention is to provides an economical method that does not have the above problems and defects caused by existing devices and existing producing methods and is capable of obtaining a very small spherical particle, in particular, a resin particle, in more detail, a resin particle having a particle size from micro-meter to sub-micrometer; a resin particle produced by the method; a toner and a developer containing the resin particle; a developing device and image forming apparatus for forming an image with the developer.

Furthermore, an object of the invention is to provide a grinding method or milling method for making a particle size smaller for obtaining a clean, dry and small resin particle such as a resin particle from substantially 0.1 μm to substantially 5 μm in volume average particle size measured by, for example, a scanning electron microscope or a Malvern system 3601 particle size analyzer; a resin particle produced by the method; a toner and a developer containing the resin particle; a developing device and image forming apparatus for forming an image with the developer.

Furthermore, an object of the invention is to provide a clean and dry resin particle having a particle size from single micrometer (1 μm or more and less than 10 μm) to sub-micrometer that may be used as a wet and dry electrophotographic developer composition, carrier powder coating, a photoconductive pigment resin coating suspension and a photoreceptor cleaning toner additive at low cost; a producing method thereof; a toner and a developer containing the resin particle; a developing device and image forming apparatus for forming an image with the developer.

The invention provides a producing method of spherical particles, comprising a pulverizing step for passing a dispersion liquid of coarse particles of material to be processed, which dispersion liquid includes a polymer dispersant and the coarse particles of material to be processed dispersed in a liquid medium, through a high-pressure homogenizer having a stepwise pressure release mechanism and milling the coarse particles of material to be processed contained in the dispersion liquid under conditions where a melt viscosity of the dispersion liquid at a time point of passing the nozzle portion of the high-pressure homogenizer is 5000 cP or less.

According to the invention, the producing method of spherical particles includes a pulverizing step. In the pulverizing step, a dispersion liquid of coarse particles of material to be processed, which includes a polymer dispersant and coarse particles of material to be processed dispersed in a liquid medium is passed through a high-pressure homogenizer having a stepwise pressure release mechanism and by which coarse particles of material to be processed contained in the dispersion liquid are milled under conditions where the melt viscosity of the dispersion at the time point of passing the nozzle portion of the high-pressure homogenizer is 5000 cP or less.

When a high-pressure homogenizer having a stepwise pressure release mechanism is used, the pressure may be gradually released and a flow rate may be controlled to a desired flow rate; accordingly, milled particles of material to be processed are inhibited from aggregating into coarse particles. As the result, problems of existing devices and particle producing methods such as frequent and repeating occurrence of the clogging of the jet nozzle may be overcome. A particle size distribution of spherical particles may be controlled and thereby spherical particles having a sharp particle size distribution may be obtained.

The minimum-attainable size of the spherical particle that may be produced by a producing method of a spherical particle of the invention is determined based on a level of the melt viscosity of the dispersion liquid of coarse particle of the material to be processed at the time point of passing through the nozzle portion. When the melt viscosity of the dispersion liquid of coarse particles of the material to be processed is 5000 cP or less, a spherical particle having a particle size from sub-micrometer to single micrometer (1 μm or more and less than 10 μm) may be obtained. Furthermore, easiness of control of a shape of a obtainable spherical particle may be increased more than the case when the melt viscosity of the dispersion liquid of coarse particle of the material to be processed exceeds 5000 cP.

When the producing method of spherical particles includes a pulverizing step where a dispersion liquid of coarse particles of material to be processed, which includes a polymer dispersant and coarse particles of material to be processed dispersed in a liquid medium is passed through a high-pressure homogenizer having a stepwise pressure release mechanism and by which coarse particles in material to be processed contained in the dispersion liquid are milled under conditions where the melt viscosity of the dispersion liquid at the time point of passing the nozzle portion of the high-pressure homogenizer is 5000 cP or less, spherical particles having a sharp particle size distribution and a particle size from sub-micrometer to single micrometer (1 μm or more and less than 10 μm) may be cheaply and readily obtained.

Furthermore, the invention provides a spherical particle produced by the producing method of the spherical particle mentioned above.

According to the invention, the spherical particle is produced according to a producing method of a spherical particle of the invention. The spherical particle produced by the producing method of spherical particles of the invention has a sharp particle size distribution as mentioned above; accordingly, when such a spherical particle is applied to, for example, an electrophotographic field, a developer homogeneous in the performance may be obtained.

Furthermore, in the invention, it is preferable that its volume average particle size is 0.1 μm or more and 2 μm or less and a coefficient of variation CV of the volume particle size distribution represented by the following expression (1) is 20% or less:

Coefficient of variation CV(%)={(Standard deviation of volume particle size distribution)/(Volume average particle size)}×100 (1).

According to the invention, the spherical particle has a volume average particle size of 0.1 μm or more and 2 μm or less and the coefficient of variation CV of the volume particle size distribution represented by the expression (1) of 20% or less. The spherical particles like this may form a wet developer excellent in the cleaning property for example in an electrophotographic field. Furthermore, when the spherical particles are aggregated, an aggregated toner homogeneous in shape and particle size may be obtained.

In the invention, it is preferable that the spherical particle includes at least a resin.

According to the invention, the spherical particle includes at least a resin. When the spherical particle includes at least a resin, the spherical particle may be used as well as a toner in the electrophotographic field for example.

Furthermore, the spherical particle may be used as a shell material of a capsule particle.

Furthermore, the invention provides a toner including the spherical particle mentioned above.

According to the invention, a toner contains the spherical particle of the invention. The spherical particle of the invention has a sharp particle size distribution and a particle size from sub-micrometer to single micrometer (1 μm or more and less than 10 μm); accordingly, when a toner containing the spherical particle of the invention is used in an electrophotographic field, in both of a dry development process and a wet development process, high quality images are stably formed.

In the invention, it is preferable that the toner contains a binder resin, the binder resin being at least one of a polyester resin, an acrylic resin and an epoxy resin.

According to the invention, the toner contains a binder resin, the binder resin being at least one of a polyester resin, an acrylic resin and an epoxy resin. When the toner contains the binder resin, a toner having preferable performance in both of a dry development process and a wet development process may be realized. Specifically, when a color toner contains the binder resin, since the binder resin is excellent in the transparency, a color toner having excellent powder fluidity, low temperature developability and secondary color reproducibility may be realized.

In the invention, it is preferable that a glass transition temperature of the binder resin is 40° C. or more and 70° C. or less and a weight average molecular weight of the binder resin is 10,000 or more and 300,000 or less.

According to the invention, the glass transition temperature of the binder resin is 40° C. or more and 70° C. or less and the weight average molecular weight of the binder resin is 10,000 or more 300,000 or less. When the glass transition temperature of the binder resin is less than 40° C., the physical properties of the toner such as the storability are remarkably deteriorated. When the glass transition temperature of the binder resin exceeds 70° C., the low temperature fixability is deteriorated. When the weight average molecular weight of the binder resin is less than 10,000, the mechanical strength of the fixed toner is lower in comparison with the case where the weight average molecular weight of the binder resin is 10,000. For instance, there is a fear of an image omission where a formed image falls off a recording medium. When the weight average molecular weight of the binder resin exceeds 300,000, the low temperature fixability is deteriorated. When the glass transition temperature of the binder resin is 40° C. or more and 70° C. or less and the weight average molecular weight of the binder resin is 10,000 or more 300,000 or less, the physical properties of the toner such as the storability are made excellent, a fixable temperature range is largely expanded and the image omission is inhibited from occurring; accordingly, high quality images may be formed more stably.

In the invention, it is preferable that the toner includes a release agent.

According to the invention, the toner contains the release agent. When the toner contains the release agent, the releasability between a fixing section and a recording medium may be more heightened and the fixability is improved in a fixing step than a toner that does not contain the release agent. Accordingly, a fixable temperature range may be largely expanded and thereby high quality images are more stably formed.

In the invention, it is preferable that the release agent has a melting temperature of 30° C. or more and 120° C. or less.

According to the invention, the melting temperature of the release agent is 30° C. or more and 120° C. or less. When the melting temperature of the release agent is less than 30° C., the storability of the toner may be deteriorated. When the melting temperature of the release agent exceeds 120° C., the fixability may not be fully improved. When the melting temperature of the release agent is 30° C. or more and 120° C. or less, the fixability is sufficiently improved and the toner storability is improved.

The invention provides a toner comprising a toner base particle including the spherical particle mentioned above and a release agent, and the spherical particle mentioned above with which a surface of the toner base particle is covered.

According to the invention, a toner comprises a toner base particle including the spherical particle and the release agent, and the spherical particle with which a surface of the toner base particle is covered. When a surface of the toner base particle is covered with the spherical particle of the invention, inconveniences caused by incorporation of the release agent in the case where the toner base particle contains the release agent are inhibited from occurring; accordingly, a toner having excellent fixability, storability and durability may be realized. In particular, when the toner is used as a dry developer, advantages of capable of obtaining excellent fixability, storability and durability may be remarkably exerted. Furthermore, as mentioned above, the spherical particles of the invention have a sharp particle size distribution; accordingly, a surface of the toner base particle may be uniformly covered and thereby a uniformly charged toner is formed. As the result, the fixability, storability and durability are made excellent and the charging property is made more uniform; accordingly, high-quality images are more stably formed.

The invention provides a developer comprising the toner mentioned above.

According to the invention, a developer contains the toner of the invention. The toner of the invention has a sharp particle size distribution; accordingly, when a developer contains a toner of the invention, a developer uniform in the performance may be realized.

The invention provides a developing device for forming a toner image by developing a latent image formed on an image hearing member by use of the developer mentioned above.

According to the invention, a latent image is developed with a developer of the invention; accordingly, high quality toner images may be stably formed on an image bearing member. Accordingly, high image quality images may be stably formed.

The invention provides an image forming apparatus comprising:

an image bearing member on which a latent image is to be formed;

a latent image forming section for forming a latent image on the image bearing member; and

the developing device mentioned above.

According to the invention, an image forming apparatus is realized by including an image bearing member on which a latent image is to be formed; a latent image forming section for forming a latent image on the image bearing member; and a developing device of the invention, which is capable of forming a high quality toner image as mentioned above. When an image is formed with such an image Forming apparatus, high quality images are stably formed.

### BRIEF DESCRIPTION OF DRAWINGS

Other and further objects, features, and advantages of the invention will be more explicit from the following detailed description taken with reference to the drawings wherein:

FIG. 1 is a flowchart showing a procedure of a producing method of a spherical particle according to the embodiment;

FIG. 2 is a schematic sectional view schematically showing a configuration of a dry process image forming apparatus according to a fifth embodiment of the Invention; and

FIG. 3 is a schematic sectional view schematically showing a configuration of a wet process image forming apparatus according to a sixth embodiment of the invention.

### DETAILED DESCRIPTION

Now referring to the drawings, preferred embodiments of the invention are described below.

1. Producing Method of Spherical Particle

A producing method of a spherical particle according to a first embodiment of the invention includes a pulverizing step for passing a dispersion liquid of coarse particles of material to be processed, which dispersion liquid includes a polymer dispersant and the coarse particles of material to be processed dispersed in a liquid medium, through a high-pressure homogenizer having a stepwise pressure release mechanism and milling coarse particles of material to be processed contained in the dispersion liquid under conditions where a melt viscosity of the dispersion liquid at a time point of passing the nozzle portion of the high-pressure homogenizer is 5000 cP or less.

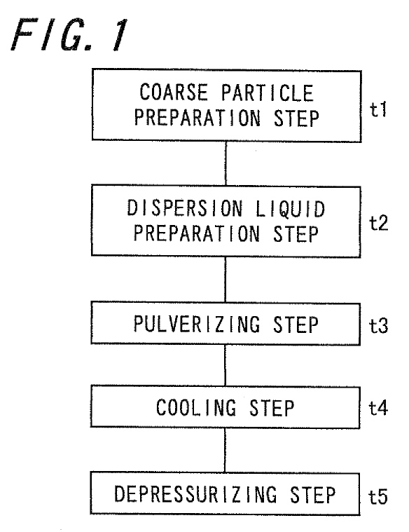

FIG. 1 is a flowchart showing a procedure of a producing method of spherical particles according to the embodiment. A producing method of a spherical particle according to the embodiment includes a coarse particle preparation step t1, a dispersion Liquid preparation step t2, a pulverizing step t3, a cooling step t4 and a depressurizing step t5. In the coarse particle preparation step t1, material to be processed is coarsely pulverized to obtain coarse particles of material to be processed. In the dispersion liquid preparation step t2, the coarse particles of the material to be processed obtained in the coarse particle preparation step t1 are mixed with a liquid medium and dispersed and thereby a dispersion liquid of coarse particles of the material to be processed, in which the coarse particles of the material to be processed are dispersed in a liquid medium is prepared. In the pulverizing step t3, the coarse particles of the material to be processed contained in the dispersion liquid of coarse particles of the material to be processed obtained in the dispersion liquid preparation step t2 are milled and thereby a dispersion liquid of spherical particles, in which milled coarse particles of the material to be processed are dispersed in the liquid medium is prepared. In the cooling step t4, the dispersion liquid of the spherical particles obtained in the pulverizing step t3 is cooled. In the depressurizing step t5, the dispersion liquid of spherical particles obtained in the cooling step t4 is depressurized.

In the embodiment, a high-pressure homogenizer method is used to produce spherical particles. In the embodiment, a high-pressure homogenizer method is a method where material to be processed such as a synthetic resin is milled or granulated by use of a high-pressure homogenizer provided with a stepwise pressure release mechanism. The high-pressure homogenizer is an apparatus that pulverizes particles such as resin coarse particles under pressure. When the high-pressure homogenizer provided with a stepwise pressure release mechanism is used, pressure is gradually released and a flow rate is controlled to a desired flow rate; accordingly, milled coarse particles of the material to be processed are inhibited from aggregating. As the result, problems of existing apparatuses and particle producing methods such as frequent and repeating occurrence of the clogging of the jet nozzle may be overcome. A particle size distribution of spherical particles may be controlled and thereby spherical particles having a sharp particle size distribution may be obtained.

(High-Pressure Homogenizer Having Stepwise Pressure Release Mechanism)

As a high-pressure homogenizer having a stepwise pressure release mechanism (hereinafter, simply referred to as “high-pressure homogenizer”), it is possible to use commercially available products or those disclosed in patent documents or the like. Examples of the high-pressure homogenizers commercially available include chamber type high-pressure homogenizers such as Microfluidizer (trade name, manufactured by Microfluidics), Nanomizer (trade name, manufactured by Nanomizer Co., Ltd.), Ultimizer (trade name, manufactured by Sugino Machine Ltd.), —High-Pressure Homogenizer (trade name, manufactured by Rannie Co., Ltd.), High-Pressure Homogenizer (trade name, manufactured by Sanmaru Machinery Co., Ltd.), and High-Pressure Homogenizer (trade name, manufactured by Izumi Food Machinery Co., Ltd.). Also, examples of the high-pressure homogenizers disclosed in patent documents include high-pressure homogenizers disclosed in WO03/059497. Among these machines preferable is a high-pressure homogenizer disclosed in WO03/059497.

In the high-pressure homogenizer method using the high-pressure homogenizer disclosed in WO03/059497, the pulverizing step t3, the cooling step t4, and the depressurizing step t5 can be carried out.

In what follows, a producing method of a spherical particle of the embodiment shown in FIG. 1 will be specifically described.

(1) Coarse Particle Preparation Step t1

In the coarse particle preparation step t1, material to be processed is coarsely pulverized to obtain coarse particles of the material to be processed. Examples of the material to be processed include synthetic resins and titanium oxide. When a synthetic resin is used as the material to be processed, a melt-kneaded material containing the synthetic resin alone or a melt-kneaded material obtained by mixing a synthetic resin and additives such as a colorant, a release agent and a charge control agent is coarsely pulverized and thereby coarse particles of the material to be processed are obtained.

In the following description of the producing method of spherical particles, a case where a synthetic resin is used as the material to be processed and, in addition to the synthetic resin, additives such as a colorant, a release agent and an charge control agent are contained will be described.

In order to obtain a melt-kneaded product, additives such as a colorant, a release agent and a charge control agent are preferably melt-kneaded together with a synthetic resin that is a raw material of a spherical particle. The melt-kneaded product may be produced in such a manner that a synthetic resin and additives such as a colorant, a release agent and a charge control agent are mixed in powder and melt-kneaded under heating at a temperature equal to or more than the melting temperature of the synthetic resin, usually substantially from 80 to 200° C., preferably substantially from 100 to 150° C.

As the kneading machine for performing melt-kneading, it is possible to use typical kneading machines such as a twin screw extruder, a three-roll machine, and a laboplast mill. More specifically, for example one screw or twin screw extruders such as TEM-100B (trade name, manufactured by Toshiba Machine Co., Ltd.), PCM-65/87 (trade name, manufactured by Ikegai Ltd.); and open roll type extruders such as Kneadex (trade name, manufactured by Mitsui Mining Co., Ltd.) can be used.

A resulting melt-kneaded product is cooled to obtain a solidified product. The cooled solidified product is coarsely pulverized by using the powder mills such as the cutter mill, the feather mill, and the jet mill to obtain coarse particles of the synthetic resin. A particle size of the coarse particles of the synthetic resin includes, but not be limited to, preferably a range of 450 to 1,000 μm, more preferably a range of around 500 to 800 μm.

(Synthetic Resin)

The synthetic resin is not particularly restricted as long as it is a thermoplastic resin. Examples thereof include a polyester resin, an acrylic resin, a polyurethane resin and an epoxy resin.

As the polyester, known ones can be used. For instance, a polycondensate of a polybasic acid and a polyhydric alcohol can be cited.

As the polybasic acid, ones known as monomers for polyester can be used and examples thereof include aromatic carboxylic acids such as terephthalic acid, isophthalic acid, phthalic anhydride, trimelitic anhydride, pyromelitic acid and naphthalene dicarboxylic acid; aliphatic carboxylic acids such as maleic anhydride, fumaric acid, succinic acid, alkenyl succinic anhydride and adipic acid; and a methylesterized substance of these polybasic acids. The polybasic acids may be used each alone, or two or more of them may be used in combination.

As the polyhydric alcohol as well, ones known as monomers for polyester can be used and examples thereof include: aliphatic polyhydric alcohols such as ethylene glycol, propylene glycol, butanediol, hexanediol, neopentyl glycol and glycerin; alicyclic polyhydric alcohols such as cyclohexanediol, cyclohexanedimethanol and water-added bisphenol A; and aromatic diols such as an ethylene oxide adduct of bisphenol A and propylene oxide adduct of bisphenol A. The polyhydric alcohols may be used each alone, or two or more of them may be used in combination.

A polycondensation reaction of a polybasic acid and a polyhydric alcohol can be carried out according to a standard process. For instance, in the presence or absence of an organic solvent and in the presence of a polycondensation catalyst, a polybasic acid and a polyhydric alcohol are brought into contact to conduct the polycondensation reaction and the reaction is terminated when the acid value and softening temperature of generated polyester reach predetermined values. Polyester can be thus obtained. When the polybasic acid is partially replaced by a methyl esterified compound of the polybasic acid, a demethanolation polycondensation reaction is caused. In the polycondensation reaction, when a blending ratio of the polybasic acid and polyhydric alcohol and a reaction rate are appropriately varied, for instance, a carboxyl group content at a terminal of polyester can be controlled and thereby the characteristics of obtained polyester can be controlled.

The acrylic resin is not particularly restricted, and an acrylic resin containing an acidic group can be preferably used. The acrylic resin containing the acidic group can be produced when, for instance, at polymerizing an acrylic resin monomer or an acrylic resin monomer and a vinyl monomer, an acrylic resin monomer containing an acidic group or a hydrophilic group and/or a vinyl monomer having an acidic group or a hydrophilic group are used together.

As the acrylic resin monomers, known ones can be used and examples thereof include acrylic acid that may have a substituent, methacrylic acid that may have a substituent, acrylic acid ester that may have a substituent and methacrylic acid ester that may have a substitutent. The acrylic resin monomers may be used each alone, or two or more of them may be used in combination.

As the vinyl monomers, known ones can be used and examples thereof include styrene, α-methylstyrene, vinyl bromide, vinyl chloride, vinyl acetate, acrylonitrile and methacrylonitrile. The vinyl monomers may be used each alone, or two or more of them may be used in combination. Polymerization is carried out with a general radical initiator by use of a solution polymerization process, a suspension polymerization process or an emulsion polymerization process.

Polyurethane is not particularly restricted, and for instance, polyurethane containing an acidic group or a basic group can be preferably used. The polyurethane containing an acidic group or a basic group can be produced according to a Known process. For instance, diol containing an acidic group or a basic group, polyol and polyisocyanate may well be addition polymerized. As the diol containing an acidic group or a basic group, for instance, dimethylolpropionic acid and N-methyldiethanolamine can be cited. As the polyol, for instance, polyether polyol such as polyethylene glycol, polyester polyol, acryl polyol and polybutadiene polyol can be cited. As the polyisocyanate, for instance, tolylene diisocyanate, hexamethylene diisocyanate and isophorone diisocyanate can be cited. The respective components may be used each alone, or two or more of them may be used in combination.

The epoxy resin is not particularly restricted, and an epoxy resin containing an acidic group or a basic group can be preferably used. The epoxy resin containing an acidic group and a basic group can be produced by adding or addition polymerizing for instance polyvalent carboxylic acid such as adipic acid and trimelitic anhydride or amine such as dibutylamine or ethylenediamine to epoxy resin that serves as a base.

Concrete examples of additives such as a colorant, a release agent, and a charge control agent will be described below.

(2) Dispersion Liquid Preparation Step t2

In the dispersion liquid preparation step t2, coarse particles of the synthetic resin (hereinafter, referred to as “resin coarse particles”>obtained in the coarse particle preparation step t1 and a liquid medium are mixed to disperse the resin coarse particles in the liquid medium, and thereby a dispersion liquid of coarse particles of a resin processed material is prepared.

A general mixer is used to mix the resin coarse particles and a liquid medium. Examples of the mixer include PUC COLLOID MILL (trade name, manufactured by Nippon Ball Valve Co., Ltd.), a friction atomizer (trade name: T. K. MYCOLLOIDER (R) M, manufactured by Primix Corporation) and SUPER MUSKOLLOIDER (trade name, manufactured by Kasuko Sangyo Co., Ltd.).

(Liquid Medium)

The liquid medium mixed with the resin coarse particles is not particularly restricted as far as the liquid matter does not dissolve but can uniformly disperse the resin coarse particles. However, when easiness in the process management, waste liquid disposal after all steps and handling easiness are considered, water is preferred.

An addition amount of the resin coarse particles to the liquid medium is not particularly restricted. However, the addition amount is, based on a sum total of the resin coarse particles and liquid medium, preferably 3% by weight or more and 45% by weight or less and more preferably 5% by weight or more and 30% by weight or less. The resin coarse particles and the liquid medium may be mixed under heating or cooling but usually under room temperature.

(Polymer Dispersant)

The dispersion liquid of resin coarse particles contains a dispersion stabilizer. The dispersion stabilizer is added to the liquid medium preferably before the resin coarse particles are added to the liquid medium. As the dispersion stabilizer, a polymer dispersant durable to a high temperature and high pressure when spherical particles are produced is necessarily used.

As such a polymer dispersant, a polymer dispersant having also aggregating ability may be used. The polymer dispersant having also the aggregating ability is a polymer dispersant that has the dispersibility and aggregating ability, works as a dispersant during from the dispersion liquid preparation step t2 to the depressurizing step t5 and, when obtained spherical particles are aggregated after the depressurizing step t5, works as an aggregating agent. When the spherical particles are aggregated, the polymer dispersant having also the aggregating ability is electrically neutralized by adding a cationic dispersant to a dispersion liquid of spherical particles containing a polymer dispersant, thereby dispersion stability of the polymer dispersant is lost; as the result, so far dispersed spherical particles are aggregated.

Examples of the polymer dispersant include (meth) acrylic polymers; polyoxyethylene polymers including polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester and polyoxyethylene nonyl phenyl ester; and cellulose polymers including methyl cellulose, hydroxyethyl cellulose and hydroxypropyl cellulose. The (meth)acrylic polymers contains one or two of hydrophilic monomers selected from: an acrylic monomer such as (meth) acrylic acid, α-cyanoacrylic acid, α-cyanomethacrylic acid, itaconic acid, crotonic acid, fumaric acid, maleic acid, or maleic anhydride; a hydroxyl group-containing acrylic monomer such as β-hydroxyethyl acrylic acid, β-hydroxyethyl methacrylic acid, β-hydroxypropyl acrylic acid, β-hydroxypropyl methacrylic acid, γ-hydroxypropyl acrylic acid, γ-hydroxypropyl methacrylic acid, 3-chloro-2-hydroxypropyl acrylic acid or 3-chloro-2-hydroxypropyl methacrylic acid; an ester monomer such as diethylene glycol monoacrylate, diethylene glycol monomethacrylate, glycerin monoacrylate or glycerin monomethacrylate; a vinyl alcohol monomer such as N-methylol acrylamide or N-methylol methacrylamide; a vinyl alkyl ether monomer such as vinyl methyl ether, vinyl ethyl ether or vinyl propyl ether; a vinyl alkyl ester monomer such as vinyl acetate, vinyl propionate or vinyl butyrate; an aromatic vinyl monomer such as styrene, α-methylstyrene or vinyl toluene; an amide monomer such as acrylamide, methacrylamide, diacetone acrylamide or methylol compounds thereof; a nitrile monomer such as acrylonitrile or methacrylamide; an acid chloride monomer such as acrylic acid chloride or methacrylic acid chloride; a vinyl nitrogen-containing heterocyclic monomer such as vinylpyridine, vinylpyrrolidone, vinylimidazole or ethyleneimine; and a crosslinkable monomer such as ethylene glycol dimethacrylate, diethylene glycol dimethacrylate, allyl methacrylate or divinyl benzene. However, the polymer dispersant is not restricted thereto.

The polymer dispersant may be used together with another dispersant to improve the wettability of a material. Examples of the dispersant that may be used together include polyoxyalkylene alkylaryl ether sulfate such as sodium polyoxyethylene laurylphenyl ether sulfate, potassium polyoxyethylene laurylphenyl ether sulfate, sodium polyoxyethylene nonylphenyl ether sulfate, sodium polyoxyethylene oleylphenyl ether sulfate, sodium polyoxyethylene cetylphenyl ether sulfate, ammonium polyoxyethylene laurylphenyl ether sulfate, ammonium polyoxyethylene nonylphenyl ether sulfate or ammonium polyoxyethylene oleylphenyl ether sulfate; and polyoxy alkylene alkyl ether sulfate such as sodium polyoxyethylene lauryl ether sulfate, potassium polyoxyethylene lauryl ether sulfate, sodium polyoxyethylene oleyl ether sulfate, sodium polyoxyethylene cetyl ether sulfate, ammonium polyoxyethylene lauryl ether sulfate or ammonium polyoxyethylene oleyl ether sulfate. The dispersant is not restricted thereto.

An addition amount of the dispersion stabilizer including the dispersant for improving the wettability of a material is not particularly restricted. However, it is preferably 0.05% by weight or more and 10% by weight or less and more preferably 0.1% by weight or more and 3% by weight or less relative to a total amount of the liquid medium and dispersion stabilizer.

Thus obtained dispersion liquid of resin coarse particles may be supplied per se to the pulverizing step t3. However, as a pre-treatment, a general coarse pulverization process may be applied and thereby a particle size of the resin coarse particles may be coarsely pulverized to substantially 100 μm, and more preferably to 100 μm or less. The coarse pulverization process is carried out by passing the dispersion liquid of resin coarse particles through a general pressure-proof nozzle under high pressure.

(3) Pulverizing Step t3

In the pulverizing step t3, a dispersion liquid of resin coarse particles obtained in the dispersion liquid preparation step t2 is passed through a pressure-resistant nozzle under heating and pressure to mill the resin coarse particles contained in the dispersion liquid of resin coarse particles into fine particles, and thereby a dispersion liquid of spherical particles is obtained.

The pressurizing and heating conditions of the dispersion liquid of resin coarse particles are not particularly restricted. However, it is necessary to apply pressure under a heating condition by which the melt viscosity of the dispersion liquid of resin coarse particles is 5000 cP or less at the time point of going through a nozzle portion of the high-pressure homogenizer.

A minimum-achievable size of the spherical particles produced according to the embodiment is determined by a level of the melt viscosity of the dispersion liquid of resin coarse particles at the time point of passing through the nozzle portion. When the melt viscosity of the dispersion liquid of resin coarse particles at the time point of passing through the nozzle portion is 5000 cP or less, spherical particles having a particle size from sub-micrometer to single-micrometer (1 μm or more and less than 10 μm) may be obtained. In this case, more than the case where the melt viscosity of the dispersion liquid of resin coarse particles exceeds 5000 cP, the easiness of control of a shape of obtained spherical particles may be increased. Accordingly, the spherical particles having a sharp particle size distribution and a particle size from sub-micrometer to single micrometer (1 μm or more and less than 10 μm) may be cheaply and readily obtained.

The dispersion liquid of resin coarse particles is introduced from an inlet of a pressure-resistant nozzle into the pressure-resistant nozzle. A dispersion liquid of spherical particles, which is discharged from an outlet of the pressure-resistant nozzle, for example, contains sub-micrometer spherical particles having a particle size from 0.3 to 1 μm, is heated to 60° C. or more and the glass transition temperature of the resin particles Tm+60° C. or less, and is pressurized to substantially 150 to 250 MPa. The pressure-resistant nozzle may be provided alone, or a plurality of pressure-resistant nozzles may be provided.

(Nozzle)

As the nozzle, it is possible to use a typical pressure-resistant nozzle capable of flowing fluid. For example, a multiple nozzle having a plurality of liquid flowing passages can be preferably used. The liquid flowing passage constituting the multiple nozzle may be concentrically arranged centering around an axis line of the multiple nozzle, or the plurality of liquid flowing passages may be arranged substantially parallel to one another in a longitudinal direction of the multiple nozzle. One example of the multiple nozzle used in the producing method of the spherical particle according to the embodiment includes a nozzle provided with one or more, preferably one or two liquid flowing passages having an inlet diameter and an outlet diameter of around 0.05 to 0.35 mm and a length of 0.5 to 5 cm.

(4) Cooling Step t4

The dispersion liquid of heated and pressurized spherical particles containing milled resin coarse particles discharged from the nozzle in the pulverizing step t3 is cooled in the cooling step t4. The cooling temperature is not particularly restricted. However, according to one measure thereof, the dispersion liquid of spherical particles is cooled to a temperature of 30° C. or less. When the temperature of the dispersion liquid of spherical particles is lowered to 30° C. or less, the pressure applied on the dispersion liquid of spherical particles is lowered to substantially 5 to 20 MPa.

For example, the dispersion liquid of spherical particles, which is discharged from the pressure-resistant nozzle in the pulverizing step t3, is introduced from the inlet of the cooling machine into the cooling machine, cooled within the cooling machine having the cooling gradient, and is discharged from the outlet of the cooling machine. The cooling machine may be provided alone, or a plurality of cooling machines may be provided.

Any typical fluid cooling machines having a pressure-resistant structure can be applied for cooling, and among such cooling machines preferable is a cooling machine having a wide cooling area such as a corrugated tube type cooling machine. Also, it is preferable that the fluid cooling machine is configured so that a cooling gradient from an inlet of the cooling machine to an outlet thereof is decreased (or cooling capability therefrom/thereto is decreased). As a result, milling of the resin coarse particles is even more efficiently achieved. Furthermore, milled resin coarse particles are inhibited from adhering each other to be coarser; accordingly, the yield of the spherical particles may be improved.

(5) Depressurizing Step t5

In the depressurizing step t5, the dispersion liquid of spherical particles under pressure, which contains the spherical particles obtained in the cooling step t4, is depressurized down to such a level that the dispersion liquid causes no bubbling, that is, there is no production of bubbles. The dispersion liquid of spherical particles led from the cooling step t4 to the depressurizing step t5 is pressurized to around 5 to 80 MPa. The dispersion liquid is gradually depressurized in a stepwise manner.

A multistage depressurizing apparatus disclosed in WO03/059497 is preferably used for this depressurizing operation. The multistage depressurizing apparatus includes an inlet passage, an outlet passage, and a multistage depressurizing section. The inlet passage directs the dispersion liquid of spherical particles into the multistage depressurizing apparatus. The outlet passage is arranged to communicate with the inlet passage, and discharges the dispersion liquid of spherical particles depressurized to an outside of the multistage depressurizing apparatus. The multistage depressurizing section is disposed between the inlet passage and the outlet passage, to which two or more depressurizing members are linked via linking members.

Examples of the depressurizing member used for the multistage depressurizing section in the multistage depressurizing apparatus include a pipe-shaped member. Examples of the linking member include a ring-shaped seal. The multistage depressurizing section is configured by linking the plurality of pipe-shaped members having various inner diameters to each other using the ring-shaped seal. For example, from the inlet passage toward the outlet passage, two to four pipe-shaped members having a common diameter are linked to each other, and to these pipe-shaped members is then one pipe-shaped member having a inner diameter about twice larger than that of these pipe-shaped members linked, and to these pipe-shaped members are further one to three pipe-shaped members having a inner diameter around 5% to 20% smaller than that of the one pipe-shaped member further linked. As a result, the dispersion liquid of spherical particles flowing through the pipe-shared members is gradually depressurized and finally depressurized down to such a level that the dispersion liquid causes no bubbling, preferably to the atmospheric pressure.

A heat exchange section employing a cooling medium and a heating medium may be disposed around the multistage depressurizing section to cool or heat in accordance with a pressure value applied to the dispersion liquid of spherical particles.

For example, the dispersion liquid of spherical particles obtained in the cooling step t4 is supplied from the cooling step t4 into the depressurizing step t5 by disposing a pressure-resistant pipe between a part designed for the cooling step t4 and a part designed for the depressurizing step t5 and by disposing a supply pump and a supply valve on the pressure-resistant pipe, and introduced into the inlet passage of the multistage depressurizing apparatus.

The dispersion liquid of spherical particles depressurized in a multistage depressurizing apparatus is discharged from the outlet passage outside of the multistage depressurizing apparatus. The multistage depressurizing apparatus may be provided alone, or a plurality of multistage depressurizing apparatuses may be provided.

In the above-mentioned producing method of the spherical particle, a process including the steps of t1 to t5 as described above may be implemented only once, or thereafter the steps of t3 to t5 may be repeated.

A dispersion liquid of spherical particles, which contains milled resin coarse particles is thus obtained. When the spherical particles produced in the embodiment are used as powder, a general separation device for filtering, centrifugal separation or the like is used to apply solid-liquid separation, followed by drying.

Thus produced spherical particles, for example, per se or alter aggregating to a desired particle size, may be used in various applications such as paints, adhesives and toners. As desired sizes when the aggregated spherical particles are used as a dry toner, the spherical particles are preferably aggregated so that a particle size of aggregated spherical particles may be 3 μm or more and 10 μm or less. When particles in a range of the above-mentioned particle size are used as a dry toner, high definition and high resolution images may be formed.

(Aggregating Step)

In the embodiment, the spherical particles obtained as mentioned above may be aggregated to produce aggregate of spherical particles (hereinafter, referred to as “aggregated particles”). A method of aggregating spherical particles to obtain the aggregated particles is not particularly restricted. A method where an aggregating agent is added to a dispersion liquid of spherical particles produced by undergoing steps from the coarse particle preparation step t1 to the depressurizing step t5, followed by agitating by use of a granulator including an agitation vessel accommodating a dispersion liquid of spherical particles and an agitation portion that is disposed inside of the agitation vessel and agitates the dispersion liquid of spherical particles is cited.

According to the aggregating method, ultrafine particles that are relatively small in the particle size among the particles contained in the spherical particles are aggregated owing to flocculation force of the polymer dispersant that has aggregating ability as well. Furthermore, when an external force such as shearing force is applied to inhibit the spherical particles from excessively aggregating, coarse particles formed by excessively aggregating the spherical particles are inhibited from generating. Furthermore, when an aggregating agent such as a cationic dispersant is added to a dispersion liquid of the spherical particles containing a polymer dispersant, the polymer dispersant is electrically neutralized; accordingly, the polymer dispersant loses the dispersion stability and thereby so far dispersed spherical particles aggregate. The polymer dispersant has a long chain in a molecule thereof and is considered that the polymer dispersant per se forms a crosslink between the spherical particle and spherical particle to disperse the spherical particles in the dispersion liquid. Functional groups present a lot in a molecule of the polymer dispersant, for example, carboxyl groups in the case of polyacrylic acid are neutralized by an aggregating salt contained in the aggregating agent to be able to nullify the polymer dispersant, that is, to finely control an extent of destabilization. Accordingly, the particle size distribution is controlled from both sides of an ultrafine particle side and a coarse particle side, that is, the spherical particles may be gradually aggregated while maintaining appropriate dispersibility; accordingly, aggregated particles having a narrow particle size distribution are produced.

As the granulator, a general emulsification machine or dispersion machine capable of applying shearing force from mechanical one direction is preferably used. Thereby, particle sizes and shapes of the resulting aggregated particles are more homogenized.

Specific examples of the emulsification machine and the dispersion machine include, batch type emulsification machines such as Ultratarax (trade name, manufactured by IKA Japan Co., Ltd.), Polytoron Homogenizer (trade name, manufactured by KINEMATICA AG), TK Auto Homo Mixer (trade name, manufactured by Primix Corporation); continuous type emulsification machines such as EbaraMilder (trade name, manufactured by Ebara Corporation), TK Pipe Line Homo-Mixer (trade name, manufactured by Primix Corporation), TK Homomic Line Flow (trade name, manufactured by Primix Corporation), Filmics (trade name, manufactured by Primix Corporation), Colloid Mill (trade name, manufactured by Shinko Pantec Co., Ltd.), Slasher (trade name, manufactured by Mitsui Miike Kakoki Co., Ltd.), Trigonal Wet Fine Pulverizer (trade name, manufactured by Mitsui Miike Kakoki Co., Ltd.), Cavitoron (trade name, manufactured by Eurotec Ltd.), and Fine Flow Mill (trade name, manufactured by Pacific Machinery and Engineering Co., Ltd.); and Clearmix (trade name, manufactured by M Technique Co., Ltd.), and Filmics (trade name, manufactured by Primix Corporation).

When a dispersion liquid of spherical particles and an aggregating agent are mixed, an agitation speed, an agitation temperature and an agitation time of a granulator may be selected to appropriate values so that aggregated particles having desired particle size, particle size distribution and shape may be obtained. As to the shape of the aggregated particles, external force and heat and time, and agitation speed (rotation number of granulator) and agitation temperature and agitation time are complicatedly entwined. For instance, when an agitation temperature is high, a shape of aggregated particle comes near a sphere, when the agitation temperature is low, a grape-like distorted shape is maintained, and even when the agitation temperature is made higher, when the agitation time is short and the agitation speed is slow, the shape of the aggregated particles is distorted. Furthermore, when the agitation time is longer, the shape of the aggregated particles gradually comes near a sphere. However, when the agitation temperature is low, even after longer agitation, the shape of the aggregated particles remains distorted. Furthermore, the agitation time may be appropriately selected depending on various conditions such as kinds and concentrations of a synthetic resin, a binder resin, a colorant, other toner additives, an aggregating agent and a dispersion stabilizer.

(Aggregating Agent)

As the aggregating agent, for example, a cationic dispersant or a multi-valent metal salt may be used. Preferred cationic dispersant includes, for example, alkyltrimethyl ammonium type cationic dispersants, alkylamindeamine type cationic dispersants, alkyldimethylbenzyl ammonium type cationic dispersants, cationic polysaccharide type cationic dispersants, alkyl betain type cationic dispersants, alkylamide betain type cationic dispersants, sulfobetain type cationic dispersants, amineoxide type cationic dispersants, and metal salts. The metal salts include for example, chlorides, and sulfates of sodium, potassium, calcium, magnesium, or the like.

A polyvalent metal salt used as the aggregating agent is a divalent or higher metal salt. Preferable examples of divalent or more metal include an alkaline earth metal such as magnesium, calcium or barium and a thirteenth group element of the periodic table such as aluminum, magnesium and aluminum being particularly preferred. Specific examples of divalent or more metal salt include, for example, magnesium sulfate, aluminum sulfate, barium chloride, magnesium chloride, calcium chloride, aluminum chloride, aluminum hydroxide and magnesium hydroxide.

Among the aggregating agents, sodium chloride is preferred because the solubility to water is relatively large and a flocculation speed is mild. A usage amount of the aggregating agent is preferably in the range of 0.5 to 20 parts by weight, more preferably in the range of 0.5 to 18 parts by weight and particularly preferably in the range of 1.0 to 18 parts by weight, relative to 100 parts by weight of the dispersion liquid of fine particles. When the usage amount is less than 0.5 part by weight, the flocculation effect may be insufficient and when the usage amount exceeds 20 parts by weight, over-flocculation may be caused to result in excessively large aggregated particles.

When the spherical particles contained in the dispersion liquid of the spherical particles are aggregated as mentioned above, a dispersion liquid where aggregated particles are dispersed in a liquid medium (hereinafter, referred to as “aggregated particle slurry”) is obtained. When the aggregated particles are utilized as powder, a solid-liquid separation is applied by use of a general separation device for filtering, centrifugal separation or the like, followed by drying. A method of aggregating the spherical particles may be used as well as a method of encapsulation.

2. Spherical Particle

Spherical particles according to the second embodiment of the invention are produced according to a producing method of spherical particles according to the first embodiment of the invention. The spherical particles produced according to the first embodiment of the invention have a sharp particle size distribution as mentioned above. When such spherical particles are applied to an electrophotographic field for example, a developer homogeneous in the performances are obtained. Furthermore, the spherical particles of the embodiment may be used as well in surface modifiers, paints, adhesives and toner-related materials.

In the embodiment, the spherical particles have a volume average particle size of 0.1 μm or more and 2 μm or less and are substantially spherical particles having the coefficient of variation CV of the volume particle size distribution represented by an expression (1) shown below of 20% or less.

Coefficient of variation CV(%)={Standard deviation of volume particle size distribution)/(Volume average particle size)}×100 (1)

The volume average particle size of the spherical particles is a value measured by use of a laser diffraction/scattering particle measurement unit (such as MICROTRACK MT3000 (trade name, manufactured by Nikkiso Co., Ltd.)).

The substantially spherical particles here mean particles having the average sphericity defined by an expression (2) below of 0.960 or more.

$$Average sphericity ( a ) = {\sum }_{i = 1}^{m} ai / m \qquad ( 2 )$$

In the expression (2), “ai” represents the sphericity of a particle and is obtained by dividing a boundary length of a circle having a projection area same as a particle image by a boundary length of a projected image of the particle. The sphericity (ai) of a particle may be measured by use of, for example, a flow particle image analyzer “FPIA-3000” (trade name, manufactured by Sysmex Corporation). The sphericity of particles in the invention is the average sphericity (a) that is an average value of m particles and calculated with a calculation expression of the expression (2). This is an arithmetic average value obtained by summing up sphericities (ai) measured respectively of m particles, followed by dividing the sum total by the number of particles m.

In the analyzer “FPIA-3000”, a simplified calculation method such as mentioned below is used. That is, in the simplified calculation method, after the sphericities (ai) of the respective particles are calculated, the obtained sphericities (ai) of the respective particles are divided into 61 divisions obtained by dividing the sphericities from 0.40 to 1.00 for every 0.01 to obtain frequencies of the respective divisions, and the average sphericity is calculated with center values of the respective divisions and the frequencies thereof. The error between a value of the average sphericity calculated by the simplified calculation method and a value of the average sphericity (a) obtained by the expression (2) is very small and an extent that may be substantially neglected. Accordingly, in the embodiment, the average sphericity obtained according to the simplified calculation method will be treated as an average sphericity (a) defined by the expression (2).

The specific measurement method of the average sphericity (ai) is as follows.

In the beginning, 5 mg of particles is dispersed in 10 mL of water in which substantially 0.1 mg of a surfactant is dissolved to prepare a dispersion liquid. An ultrasonic wave of a frequency of 20 kHz and output of 50 W is irradiated for 5 min to the dispersion liquid, a particle concentration in the dispersion liquid is set in the range of 5,000 to 20,000 particles/μL, and the sphericities (ai) are measured with analyzer “FPIA-3000” to obtain the average sphericity (a).

The spherical particles like this may be formed into a wet developer excellent in the cleaning properties in, for example, an electrophotographic field. Furthermore, when the spherical particles are aggregated, aggregated toner homogeneous in shape and particle size is obtained.

The spherical particles of the embodiment may be used as a shell of a core-shell structure and thereby a range of design of core materials is largely expanded. When one having a capsule structure is produced, a material that becomes a core material and the spherical particles of the embodiment which form a shell layer are used. The material that becomes the core material is not particularly restricted. In order to use as a shell material, for example in the first embodiment of the invention, a synthetic resin is used as material to be treated, thereby spherical particles containing at least a synthetic resin are produced. The spherical particles containing the synthetic resin may be used as well as a toner.

3. Toner

A toner according to a third embodiment of the invention contains the spherical particles according to the second embodiment of the invention. The spherical particles according to the second embodiment of the invention have a sharp particle size distribution and a particle size from sub-micrometer to single micrometer (1 μm or more and less than 10 μm). Accordingly, when the spherical particles are applied as a toner in an electrophotographic field, high quality images may be stably formed in both processes of dry development and wet development.

A toner of the embodiment contains at least a binder resin and a colorant. In order to obtain a toner of the embodiment, it is preferred that, in the first embodiment of the invention, a synthetic resin is used as material to be processed and additives such as a colorant, a release agent and an charge control agent are contained together with the synthetic resin.

(Binder Resin)

The binder resin is not particularly restricted as long as it is a thermoplastic resin. The synthetic resins described in (Synthetic Resin) of the coarse particle preparation step t1 may be used. When the binder resin is used in a toner, a polyester resin, an acrylic resin, a polyurethane resin and an epoxy resin are preferably used. Among the resins, at least one of the polyester resin, acrylic resin and epoxy resin is preferably contained. When the binder resin is used, a toner having preferable performance in both processes of dry development and wet development may be realized. Specifically when the binder resin is contained in a color toner, since the binder resin is excellent in the transparency, a color toner having excellent powder fluidity, low temperature fixability and secondary color reproducibility may be realized. Furthermore, a graft polymer of polyester resin and acrylic resin as well may be preferably used.

These binder resins may be used each alone, or two or more of them may be used in combination. Moreover, two or more binder resins having differences in any or all of a molecular weight, monomer components and the like among the same binder resin may be used in combination.

In view of an easy implementation of granulating operation, a kneading property with a colorant, uniformity in shapes and sizes of the toner particles that are obtained, among the above binder resins, the binder resin having a softening temperature of 150° C. or less is preferable, and the binder resin having a softening temperature of 60 to 150° C. is especially preferable. It is preferred that the glass transition temperature of the binder resin is 40° C. or more and 70° C. or less and the weight average molecular weight of the binder resin is 10,000 or more and 300,000 or less. The glass transition temperature of the binder resin is more preferably 55° C. or more and 65° C. or less. When the glass transition temperature of the binder resin is less than 40° C., the physical property of the toner such as the storability is drastically deteriorated. On the other hand, when the glass transition temperature of the binder resin exceeds 70° C., the low temperature fixability is deteriorated. When the weight average molecular weight of the binder resin is less than 10,000, the mechanical strength of a fixed toner image is lower than the case where the weight average molecular weight of the binder resin is 10,000 or more, for instance, image omission where formed images fall out of the recording medium may be caused. When the weight average molecular weight of the binder resin exceeds 300,000, the low temperature fixability is deteriorated. When the glass transition temperature of the binder resin is 40° C. or more and 70° C. or less and the weight average molecular weight of the binder resin is 10,000 or more 300,000 or less, the physical properties of the toner such as the storability are made excellent, a fixable temperature range is largely expanded and the image omission is inhibited from occurring; accordingly, high quality images may be formed more stably.

(Colorant)

Examples of the colorant include a yellow toner colorant, a magenta toner colorant and a cyan toner colorant.

Examples of the yellow toner colorant include organic pigment such as C. I. pigment yellow 1, C. I. pigment yellow 5, C. I. pigment yellow 12, C. I. pigment yellow 15, C. I. pigment yellow 17, C. I. pigment yellow 180, C. I. pigment yellow 93, C. I. pigment yellow 74 or C. I. pigment yellow 185; inorganic pigment such as yellow iron oxide or yellow ocher; nitro dye such as C. I. acid yellow 1; and oil-soluble dye such as C. I. solvent yellow 2, C. I. solvent yellow 6, C. I. solvent yellow 14, C. I. solvent yellow 15, C. I. solvent yellow 19 or C. I. solvent yellow 21, which are all classified according to color index.

Examples of the magenta toner colorant include C.I. pigment red 49, C.I. pigment red 57, C.I. pigment red 81, C.I. pigment red 122, C.I. solvent red 19, C.I. solvent red 49, C.I. solvent red 52, C.I. basic red 10 and C.I. disperse red 15, which are all classified according to color index.

Examples of the cyan toner colorant include C.I. pigment blue 15, C.I. pigment blue 16, C.I. solvent blue 55, C.I. solvent blue 70, C.I. direct blue 25, and C.I. direct blue 86, which are all classified according to color index.

Other than the pigments, a red pigment and a green pigment may be used. The colorants may be used each alone, or two or more of them may be used in combination. Furthermore, it is possible to use two or more of the colorants of the same color series and also possible to use one or two or more of the colorants from different color series.

The colorant is preferably used in form of a master batch. The master batch of the colorant may be produced, for example, by kneading a molten product of synthetic resin and the colorant. For the synthetic resin, a resin of the same kind as that of the binder resin of the toner or a resin having high compatibility with the binder resin of the toner is used. A usage ratio of the synthetic resin and the colorant is not particularly restricted and is preferably 30 parts by weight or more and 100 parts by weight or less based on 100 parts by weight of the synthetic resin. The master batch is used, for example, with particles granulated to substantially from 2 to 3 mm in diameter.

A content of the colorant in the toner is not particularly restricted, and is preferably 2 parts by weight or more and 20 parts by weight or less based on 100 parts by weight of the binder resin. In the case where the master batch is used, a usage amount of the master batch is preferably adjusted so that a content of the colorant in the toner of the invention falls in the above range. When the usage amount of the colorant falls in the above range, it is possible to form excellent images having sufficient image density, high color developability and excellent image quality.

(Release Agent)

In the embodiment, a toner preferably contains a release agent. When the toner contains a release agent, the releasability between a fixing section and a recording medium is heightened and the fixability is improved in a fixing step more than the case of a toner that does not contain the release agent. Accordingly, a fixable temperature range may be expanded larger and thereby high quality Images are more stably formed.

The release agent used for the invention is not particularly restricted and known release agent can be used. Examples thereof include petroleum type waxes such as paraffin wax and derivatives thereof, and microcrystalline wax and derivatives thereof; hydrocarbon type synthesis waxes such as Fischer-Tropsch wax and derivatives thereof, polyolefin wax and derivatives thereof, low molecular weight polypropylene wax and derivatives thereof; polyolefin type polymer wax and derivatives thereof; carnauba wax and derivatives thereof; and ester wax. While the usage amount of the release agent in the resin particles is not particularly restricted and can be selected properly from a wide range, it is preferably 0.2 part by weight or more and 20 parts by weight or less based on 100 parts by weight of the binder resin. When the content of the release agent is more than 20 parts by weight, filming on a photoreceptor and spent to the carrier tend to occur, and when the content of the release agent is less than 0.2 part by weight, a function of the release agent may not be sufficiently exerted.

The melting temperature of the release agent is not particularly restricted but preferably 30° C. or more and 120° c. or less. When the melting temperature of the release agent is less than 30° C., the storability of the toner may be deteriorated. On the other hand, when the melting temperature of the release agent exceeds 120° C., the fixability may not be sufficiently improved. When the melting temperature of the release agent is 30° C. or more and 120° C. or less, the fixability is sufficiently improved and the storability of the toner is rendered excellent. Accordingly, the fixable temperature range is more expanded and the storability of the toner is rendered excellent, thereby high quality images are more stably formed.

(Charge Control Agent)

In the embodiment, the toner may contain a charge control agent. As the charge control agent, it is possible to use agents for controlling positive charges and agents for controlling negative charges. The charge control agent for controlling positive charges includes a basic dye, quaternary ammonium salt, quaternary phosphonium salt, aminopyrine, a pyrimidine compound, a polynuclear polyamino compound, aminosilane, a nigrosine dye and a derivative thereof, a triphenylmethane derivative, guanidine salt, and amidine salt. The charge control agent for controlling negative charges includes oil-soluble dyes such as oil black and spiron black, a metal-containing azo compound, an azo complex dye, metal salt of naphthenic acid, metal complex and metal salt of a salicylic acid and derivative thereof (the metal includes chrome, zinc, and zirconium), a boron compound, a fatty acid soap, long-chain alkylcarboxylic acid salt, and a resin acid soap. The charge control agents may be used each alone, or two or more of them may be used in combination. A usage amount of the charge control agent is preferably 0.5 part by weight or more and 5 parts by weight or less based on 100 parts by weight of the binder resin and more preferably 0.5 part by weight or more and 3 parts by weight or less based on 100 parts by weight of the binder resin. When the content of the charge control agent is more than 5 parts by weight, a carrier is contaminated and the toner is spluttered, and when the content of the charge control agent is less than 0.5 part by weight, the toner is not sufficiently imparted with the chargeability.

As the toner of the embodiment, a toner may be used which comprises a toner base particle including the spherical particle of the second embodiment o the invention and a release agent, and the spherical particle of the second embodiment with which a surface of the toner base particle is covered. When a surface of the toner base particle is covered with the spherical particle of the second embodiment of the invention, it is possible to inhibit inconveniences caused by incorporation of the release agent in the case where the toner base particle contains a release agent from occurring, and to realize a toner having excellent fixability, storability and durability. In particular, when the toner is used as a dry developer, advantages of capable of having excellent fixability, storability and durability can be remarkably exerted. Furthermore, as mentioned above, the spherical particles of the second embodiment of the invention have a sharp particle size distribution; accordingly, a surface of the toner base particle may be uniformly covered and thereby a uniformly charged toner is formed. As the result, the fixability, storability and durability are made excellent and the charging property is made more uniform, thereby high-quality images are more stably formed.

(1) Dry Toner

The toner of the embodiment may be used as a dry toner. When the toner of the embodiment is used as a dry toner, external additives that improve the powder fluidity, friction chargeability, heat resistance, long term storability and cleaning performance and control the wear resistance of a photoreceptor surface may be added to the toner.

(External Additive)

As the external additive, those usually used in the field may be used. For example, silica fine powder, titanium oxide fine powder and alumina fine powder are cited. The inorganic fine powders are preferably treated with a treatment agent such as silicone varnish, various kinds of modified silicone varnishes, silicone oil, various kinds of modified silicone oils, silane-coupling agent, a silane-coupling agent having a functional group or other organosilicon compounds to control the hydrophobicization and chargeability. The treatment agents may be used each alone, or two or more of them may be used in combination.

An addition amount of the external additive is preferably 1 part by weight or more and 10 parts by weight or less and more preferably 5 parts by weight or less to 100 parts of the toner by considering an effect on the wear of the photoreceptor caused by the addition of the external additive and environmental characteristics of the toner.

The external additive preferably has a number average particle size of primary particles of 2.0 nm or more and 500 nm or less. When the external additive having such a particle size is used, a fluidity improvement effect of the toner is more readily exerted.

(2) Wet Toner

The toner of the embodiment may be used as a wet toner. The wet toner is placed under a wet environment in a developing tank different from the dry toner and developed at a developing device to develop the wet toner on a photoreceptor surface. When the wet toner is excessively wetted in a development step, the photoreceptor potential may be leaked; accordingly, the wet toner is not excessively wetted, is not completely dried and is appropriately wetted. Accordingly, when the toner of the embodiment is used as a wet toner, a liquid bridging force that largely controls the fluidity of particles having a particle size of some extent or less is larger in comparison with the dry toner; accordingly, in the cleaning step, unlike the dry toner, the passing through is made difficult to occur.

When the toner of the embodiment is used as a wet toner, for instance, the toner of the embodiment (toner preferably having the volume average particle size of 1 μm or more and 3 μm or less) is dispersed in an insulating liquid to prepare a wet toner dispersion liquid. A preparation method of wet toner dispersion liquid is not particularly restricted and a general method may be used to prepare the wet toner dispersion liquid.

(Insulating Liquid)

Examples of the insulating liquid usable in the invention include known insulating liquids, for example, liquid n-paraffin hydrocarbons, iso-paraffin hydrocarbons, or mixtures thereof alicyclic hydrocarbons, aromatic hydrocarbons, halogenated fatty acid hydrocarbons and silicone oils. Among these, silicone oils are preferably used. When the silicone oil is used, it works as a release agent when toner particles are fixed on a recording medium; accordingly, the offset is effectively inhibited from occurring, that is, the offset resistance is improved.

The silicone oil has a polysiloxane skeleton and is constituted of a high molecule represented by a formula: —[O—SiR1(R2)]n-. Examples of the silicone oil include straight silicone oils where R1 and R2 are a methyl group, a phenyl group or a hydrogen atom; reactive modified silicone oils having an amino group, an epoxy group, a carboxyl group, a carbinol group, a methacryl group, a mercapto group or a phenol group on at least one of a side chain and a terminal; and non-reactive modified silicone oils having a polyether group, a methylstyryl group, an alkyl group, a higher fatty acid ester group, a hydrophilic specified group, a higher fatty acid group or a fluorine atom on at least one of a side chain and a terminal. These may be used each alone, or two or more of them may be used in combination. Among these, those having the non-reactively modified polysiloxane (non-reactive modified silicone) as a main component are more preferably used. When the non-reactively modified polysiloxane is used as a main component, the thermal stability of silicone oil is made higher; accordingly, a wet developer having more stable characteristics may be obtained.

At the preparation of a wet toner dispersion liquid, a dispersant soluble in the insulating liquid such as a surfactant may be used. When the dispersant soluble in the insulating liquid is used, the dispersibility of the wet toner of the invention in the insulating liquid may be improved.

A content of the wet toner of the invention in a wet toner dispersion liquid is not particularly restricted. However, the content is preferably 1% by weight or more and 30% by weight or less and more preferably 5% by weight or more and 20% by weight or less.

In the wet toner dispersion liquid, components such as a charge control agent and magnetic powder may be contained in addition to the above-mentioned components. Examples of the charge control agent include, for example, metal salts of benzoic acid, metal salts of salicylic acid, metal salts of alkyl salicylic acid, metal salts of catechol, metal-containing bisazo dyes, nigrosine dyes, tetraphenylborate derivatives, quarternary ammonium salts, alkyl pyridinium salts, chlorinated polyesters and nitrohumic acid. Examples of the magnetic powder include ones constituted of magnetic material containing, for example, a metal oxide such as magnetite, maghemite, various kinds of ferrites, cupric oxide, nickel oxide, zinc oxide, zirconium oxide, titanium oxide or magnesium oxide or magnetic metal such as Fe, Co or Ni.

Furthermore, zinc stearate, zinc oxide, or cerium oxide other than the materials such as mentioned above may be added in the dispersion liquid.

4. Developer

A developer according to a fourth embodiment of the invention includes a toner according to the third embodiment of the invention. When a developer contains the toner of the third embodiment of the invention, developers homogeneous in the performance may be obtained.

(1) Dry Developer

The dry toner to which external additives are externally added as required as mentioned above may be used per se as a one-component developer or as a two-component developer by mixing with a carrier.

When the toner is used as the one-component developer, the toner is used alone without using a carrier. When the toner is used as the one-component developer, the toner is charged by friction with a blade and a fur brush on a developing sleeve, and thereby attracted onto a developing sleeve, and then conveyed, to form an image.

When the toner is used as the two-component developer, the toner of the invention is used with the carrier. As the carrier, there may be used the well-known carriers and examples thereof include a resin-coated carrier comprising a carrier core particle of single ferrite or composite ferrite composed of iron, copper, zinc, nickel, cobalt, manganese, and chromium, and a coating substance with which a surface of the carrier core particle is coated; or a resin-dispersion carrier in which magnetic particles are dispersed in a resin.

As the coating substance of the resin-coated carrier, there may be used the well-known coating substances and examples thereof include polytetrafluoroethylene, monochlorotrifluoroethylene polymer, polyvinylidene fluoride, a silicone resin, a polyester resin, metal compounds of di-tert-butylsalicylate, a styrene resin, an acrylic resin, polyacid, polyvinyl butyral, nigrosine, an aminoacrylic resin, a basic dye, lake of a basic dye, silica fine particles, and alumina fine particles.

The resin used in a resin-dispersion carrier is not particularly restricted. Examples thereof include, for example, styrene acrylic resins, polyester resins, fluorine resins and phenol resins. Resins used in the coating substance of resin-coated carrier and resin-dispersion carrier is preferably selected in accordance with the toner component and may be used each alone, or two or more of them may be used in combination.

A shape of the carrier is preferably spherical or flat.

A particle size of the carrier is not particularly restricted. However, from the viewpoint of obtaining high quality images, the particle size is preferably 10 μm or more and 100 μm or less and more preferably 20 μm or more and 50 μm or less.

The volume resistivity of the carrier is preferably 10⁸ Ω·cm or more, and more preferably 10¹² Ω·cm or more. The resistivity of the carrier is obtained as follows. At the outset, the carrier is put in a container having a cross section of 0.50 cm², thereafter being tapped. Subsequently, a load of 1 kg/cm² is applied by use of a weight to the carrier particles which are held in the container as just stated. When an electric field of 1,000 V/cm is generated between the weight and a bottom electrode of the container by application of voltage, a current value is read. The current value indicates the resistivity of the carrier. When the resistivity of the carrier is low, electric charges will be injected into the carrier upon application of bias voltage to a developing sleeve, thus causing the carrier particles to be more easily attached to the photoreceptor. In this case, the breakdown of bias voltage is more liable to occur.

Magnetization intensity maximum magnetization) of the carrier is preferably 10 emu/g to 60 emu/g and more preferably 15 emu/g to 40 emu/g. The magnetization intensity depends on magnetic flux density of a developing roller. Under the condition of ordinary magnetic flux density of the developing roller, however, no magnetic binding force work on the carrier having the magnetization intensity less than 10 emu/g, which may cause the carrier to spatter. The carrier having the magnetization intensity larger than 60 emu/g has bushes which are too large to keep the non-contact state with the image bearing member in the non-contact development or to possibly cause sweeping streaks to appear on a toner image in the contact development.

A use ratio of the dry toner to the carrier in the two-component developer is not particularly restricted, and the use ratio is appropriately selected according to kinds of the dry toner and carrier. To take the resin-coated carrier (having density of 5 g/cm² to 8 g/cm²) as an example, the usage amount of the dry toner may be determined such that a content of the dry toner in the developer is 2% by weight to 30% by weight and preferably 2% by weight to 20% by weight of the total amount of the developer. Further, in the two-component developer, coverage of the carrier with the dry toner is preferably 40% to 80%.

(2) Wet Developer

The wet toner dispersion liquid where the wet toner is dispersed in an insulating liquid may be used per se as a wet developer. As mentioned above, the wet toner is difficult to cause the passing through unlike the dry toner in the cleaning step. Accordingly, even the spherical toner small in the particle size like the toner contained in the embodiment, a wet developer excellent in the cleaning performance may be obtained.

5. Image forming Apparatus

An image forming apparatus according to a fifth embodiment of the invention uses a developer according to the fourth embodiment of the invention.

(1) Dry Process Image Forming Apparatus

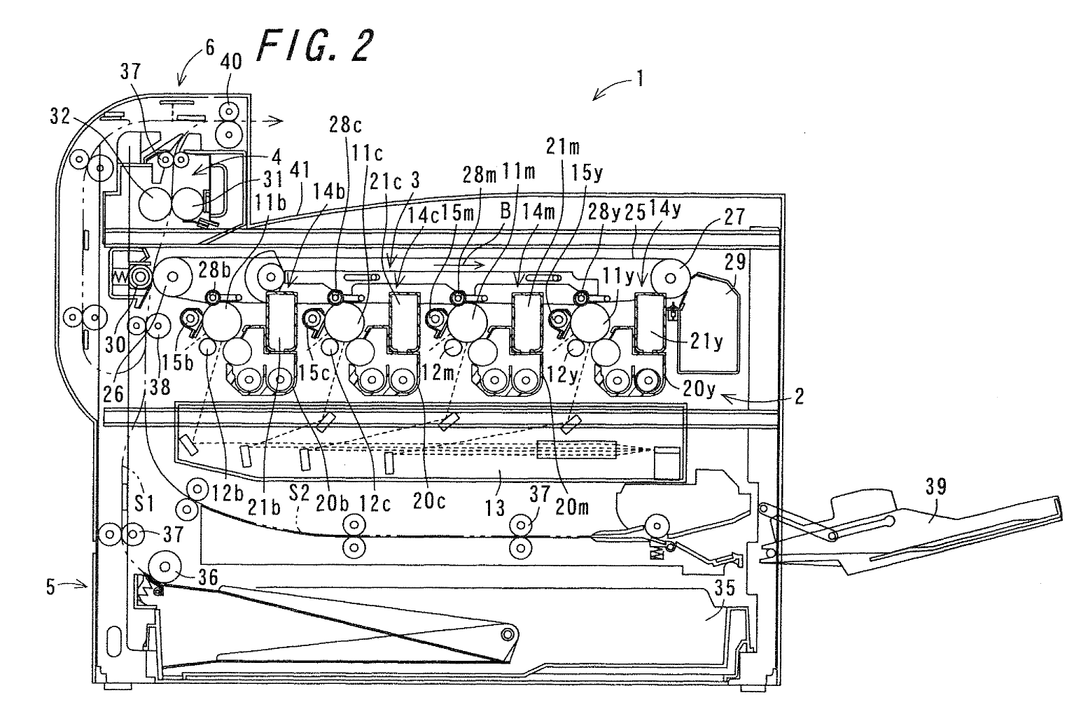

A dry developer may be used in a dry process image forming apparatus shown in, for example, FIG. 2. FIG. 2 is a schematic sectional view schematically showing a configuration of a dry process image forming apparatus 1 according to a fifth embodiment of the invention. The dry process image forming apparatus 1 is a multifunctional peripheral having a copying function, a printer function and a facsimile function and forms a full color or monochrome image on a recording medium in accordance with transmitted image information. That is, the dry process image forming apparatus 1 has three kinds of printing modes including a copier mode (copying mode), a printer mode and a FAX mode. In the dry process image forming apparatus 1, a printing mode is selected by a control unit described later in accordance with an operational input from an operating portion (not shown) or reception of a printing job from an external apparatus that uses a personal computer, a portable terminal apparatus, an information recording medium and a memory device.

The dry process image forming apparatus 1 includes a toner image forming section 2, a transfer section 3, a fixing section 4, a recording medium feeding portion 5 and a discharging portion 6. The respective members constituting the toner image forming section 2 and a part of members contained in the transfer section 3 are contained by four respectively to respond to image information of the respective colors of black (b), cyan (c), magenta (m) and yellow (y) contained in the color information. Herein, the respective members disposed by four in accordance with the respective colors are differentiated by giving an alphabet showing each of the colors to an end of a reference mark and, when these are generically called, only a reference mark is used.

The toner image forming section 2 includes a photoreceptor drum 11, a charging section 12, an exposure unit 13, a developing device 14 and a cleaning unit 15. The charging section 12, a developing device 14 and a cleaning unit 15 are disposed around a photoreceptor drum 11 in this order. The charging section 12 is disposed lower in a vertical direction than the developing device 14 and the cleaning unit 15. The charging section 12 and the exposure unit 13 correspond to a latent image forming section.

The photoreceptor drum 11 is rotatably supported around an axis thereof by a drive portion (not shown), and includes a conductive substrate and a photosensitive layer formed on a surface of the conductive substrate (not shown). The conductive substrate may be formed into various shapes such as a cylindrical shape, a circular columnar shaper and a thin film sheet shape. Among these shapes, the cylindrical shape is preferred. The conductive substrate is formed of a conductive material. As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as a synthetic resin film, a metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking a charge generating layer containing a charge generating substance, and a charge transporting layer containing a charge transporting substance. In this case, an undercoat layer is preferably formed between the conductive substrate and the charge generating layer or the charge transporting layer. When the undercoat layer is provided, the flaws and irregularities present on the surface of the conductive substrate are covered, leading to advantages such that the photosensitive layer has a smooth surface, that chargeability of the photosensitive layer can be prevented from degrading during repetitive use, and that the chargeability of the photosensitive layer can be enhanced under at least either a low temperature circumstance or a low humidity circumstance. Further, a laminated photoreceptor is also applicable which has a highly-durable three-layer structure having a photoreceptor surface-protecting layer provided on the top layer.

The charge generating layer contains as a main substance a charge generating substance that generates charges under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for forming a highly-sensitive photosensitive layer. The charge generating substances may be used each alone, or two or more of them may be used in combination. The content of the charge generating substance is not particularly restricted, and preferably 5 parts by weight or more and 500 parts by weight or less, and more preferably 10 parts by weight or more and 200 parts by weight or less based on 100 parts by weight of the binder resin in the charge generating layer.

Also as the binder resin for charge generating layer, materials used customarily in the relevant field can be used including, for example, melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester The binder resin may be used each alone, or two or more of them may be used in combination as required.

The charge generating layer can be formed by dissolving or dispersing an appropriate amount of a charge generating substance, binder resin and, optionally, a plasticizer, a sensitizer, etc. respectively in an appropriate organic solvent which is capable of dissolving or dispersing the substances described above, to thereby prepare a coating solution for charge generating layer, and then applying the coating solution for charge generating layer to the surface of the conductive substrate, followed by drying. The thickness of the charge generating layer obtained in this way not particularly restricted, and preferably 0.05 um or more and 5 μm or less, and more preferably 0.1 μm or more and 2.5 μm or less.

The charge transporting layer stacked over the charge generating layer contains as essential substances a charge transporting substance having an ability of receiving and transporting charges generated from the charge generating substance, and binder resin for charge transporting layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, bromanil, chloranil, and benzoquinone. The charge transporting substances may be used each alone, or two or more of them may be used in combination. The content of the charge transporting substance is not particularly restricted, and preferably 10 parts by weight or more and 300 parts by weight or less, and more preferably 30 parts by weight or more and 150 parts by weight or less based on 100 parts by weight of the binder resin in the charge transporting layer.

As the binder resin for charge transporting layer, it is possible to use materials which are used customarily in the relevant field and capable of uniformly dispersing the charge transporting substance, including, for example, polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resin thereof. Among those materials, in view of the film forming property, and the wear resistance, an electrical property etc. of the obtained charge transporting layer, it is preferable to use, for example, polycarbonate which contains bisphenol Z as the monomer ingredient (hereinafter referred to as “bisphenol Z polycarbonate”), and a mixture of bisphenol Z polycarbonate and other polycarbonate. The binder resin may be used each alone, or two or more of them may be used in combination.

The charge transporting layer preferably contains an antioxidant together with the charge transporting substance and the binder resin for charge transporting layer. Also for the antioxidant, substances used customarily in the relevant field can be used including, for example, Vitamin E, hydroquinone, hindered amine, hindered phenol, paraphenylene diamine, arylalkane and derivatives thereof, an organic sulfur compound, and an organic phosphorus compound. The antioxidants may be used each alone, or two or more of them may be used in combination. The content of the antioxidant is not particularly restricted, and is 0.01% by weight or more and 10% by weight or less, and preferably 0.05% by weight or more and 5% by weight or less of the total amount of the ingredients constituting the charge transporting layer.

The charge transporting layer can be formed by dissolving or dispersing an appropriate amount of a charge transporting substance, binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer followed by drying. The thickness of the charge transporting layer obtained in this way is not particularly restricted, and preferably from 10 μm to 50 μm, and more preferably from 15 μm to 40 μm.

Note that it is also possible to form a photosensitive layer in which a charge generating substance and a charge transporting substance are present in one layer. In this case, the kind and content of the charge generating substance and the charge transporting substance, the kind of the binder resin, and other additives may be the same as those in the case of forming separately the charge generating layer and the charge transporting layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 longitudinally along the photoreceptor drum 11. The charging section 12 charges the surface of the photoreceptor drum 11 so that the surface of the photoreceptor drum 11 has predetermined polarity and potential. As the charging section 12, it is possible to use a charging brush type charging device, a charger type charging device, a pin array type charging device, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum. It is also possible to use a contact-charging type charger such as a charging brush or a magnetic brush.

The exposure unit 13 is disposed so that a light beam corresponding to each color information emitted from the exposure unit 13 passes between the charging section 12 and the developing device 14 and reaches the surface of the photoreceptor drum 11. In the exposure unit 13, the image information is converted into light beams corresponding to each color information of black (b), cyan (c), magenta (m), and yellow (y), and the surface of the photoreceptor drum 11 which has been evenly charged by the charging section 12, is exposed to the light beams corresponding to each color information to thereby form electrostatic latent images on the surfaces of the photoreceptor drums 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

The developing device 14 includes a developing tank 20 and a toner hopper 21. The developing tank 20 is a container-shaped member which is disposed so as to face the surface of the photoreceptor drum 11 and used to supply a toner to an electrostatic latent image formed on the surface of the photoreceptor drum 11 so as to develop the electrostatic latent image into a visualized image, i.e. a toner image. The developing tank 20 contains in an internal space thereof the toner, and rotatably supports roller members such as a developing roller 110, a supplying roller 111, and an agitating roller 112, or screw members, which roller or screw members are contained in the developing tank 20. The developing tank 20 has an opening 114 in a side face thereof opposed to the photoreceptor drum 11. The developing roller 20a is rotatably provided at such a position as to face the photoreceptor drum 11 through the opening 114.

The developing roller 110 is a roller-shaped member for supplying a toner to the electrostatic latent image on the surface of the photoreceptor drum 11 in a pressure-contact portion or most-adjacent portion between the developing roller 110 and the photoreceptor drum 11. In supplying the toner, to a surface of the developing roller 110 is applied potential whose polarity is opposite to polarity of the potential of the charged toner, which serves as development bias voltage. By so doing, the toner on the surface of the developing roller 110 is smoothly supplied to the electrostatic latent image. Furthermore, an amount of the toner being supplied to the electrostatic latent image (which amount is referred to as “toner attachment amount”) can be controlled by changing a value of the development bias voltage.

The supplying roller 111 is a roller-shaped member which is rotatably disposed so as to face the developing roller 110 and used to supply the toner to the vicinity of the developing roller 110. The agitating roller 112 is a roller-shaped member which is rotatably disposed so as to face the supplying roller 111 and used to feed to the vicinity of the supplying roller 111 the toner which is newly supplied from the toner hopper 21 into the developing tank 20.

The toner hopper 21 is disposed so as to communicate a toner replenishment port (not shown) formed in a vertically lower part of the toner hopper 21, with a toner reception port (not shown) formed in a vertically upper part of the developing tank 20. The toner hopper 21 replenishes the developing tank 20 with the toner according to toner consumption. Further, it may be possible to adopt such configuration that the developing tank 20 is replenished with the toner supplied directly from a toner cartridge of each color without using the toner hopper 21.

The cleaning unit 15 removes the toner which remains on the surface of the photoreceptor drum 11 after the toner image has been transferred to the recording medium, and thus cleans the surface of the photoreceptor drum 11. In the cleaning unit 15, a platy member is used such as a cleaning blade. In the image forming apparatus 1 of the invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of the charging section. The degraded surface part is, however, worn away by abrasion through the cleaning unit 15 and thus removed reliably, though gradually. Accordingly, the problem of the surface degradation caused by the ozone, etc. is actually solved, and it is thus possible to stably maintain the potential of charges given by the charging operation over a long period of time. Although the cleaning unit 15 is provided in the embodiment, no limitation is imposed on the configuration and the cleaning unit 15 does not have to be provided.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing device 14 to the electrostatic latent image, thereby forming a toner image; the toner image is transferred to an intermediate transfer belt 25; and the toner which remains on the surface of the photoreceptor drum 11 is removed by the cleaning unit 15. A series of toner image forming operations just described are repeatedly carried out.

The transfer section 3 is disposed above the photoreceptor drum 11 and includes the intermediate transfer belt 25, a driving roller 26, a driven roller 27, an intermediate transfer roller 28, a transfer belt cleaning unit 29, and a transfer roller 30.

The intermediate transfer belt 25 is an endless belt stretched between the driving roller 26 and the driven roller 27, thereby forming a loop-shaped travel path. The intermediate transfer belt 25 rotates in an arrow B direction. When the intermediate transfer belt 25 passes by the photoreceptor drum 11 in contact therewith, the transfer bias voltage whose polarity is opposite to the polarity of the charged toner on the surface of the photoreceptor drum 11 is applied from the intermediate transfer roller 28 which is disposed opposite to the photoreceptor drum 11 across the intermediate transfer belt 25, with the result that the toner image formed on the surface of the photoreceptor drum 11 is transferred onto the intermediate transfer belt 2S. In the case of a multicolor image, the toner images of respective colors formed on the respective photoreceptor drums 11 are sequentially transferred and overlaid onto the intermediate transfer belt 25, thus forming a multicolor toner image.

The driving roller 26 can rotate around an axis thereof with the aid of a drive portion (not shown), and the rotation of the driving roller 26 drives the intermediate transfer belt 25 to rotate in the arrow B direction. The driven roller 27 can be driven to rotate by the rotation of the driving roller 26, and imparts constant tension to the intermediate transfer belt 25 so that the intermediate transfer belt 25 does not go slack. The intermediate transfer roller 28 is disposed in pressure-contact with the photoreceptor drum 11 across the Intermediate transfer belt 25, and capable of rotating around its own axis by a drive portion (not shown). The intermediate transfer roller 28 is connected to a power source (not shown) for applying the transfer bias voltage as described above, and has a function of transferring the toner image formed on the surface of the photoreceptor drum 11 to the intermediate transfer belt 25.

The transfer belt cleaning unit 29 is disposed opposite to the driven roller 27 across the intermediate transfer belt 25 so as to come into contact with an outer circumferential surface of the intermediate transfer belt 25. When the intermediate transfer belt 25 contacts the photoreceptor drum 11, the toner is attached to the intermediate transfer belt 25 and may cause contamination on a reverse side of the recording medium, and therefore the transfer belt cleaning unit 29 removes and collects the toner on the surface of the intermediate transfer belt 25.

The transfer roller 30 is disposed in pressure-contact with the driving roller 26 across the intermediate transfer belt 25, and capable of rotating around its own axis by a drive portion (not shown). In a pressure-contact portion (a transfer nip portion) between the transfer roller 30 and the driving roller 26, a toner image which has been carried by the intermediate transfer belt 25 and thereby conveyed to the pressure-contact portion is transferred onto a recording medium fed from the later-described recording medium feeding section 5. The recording medium bearing the toner image is fed to the fixing section 4.

In the transfer section 3, the toner image is transferred from the photoreceptor drum 11 onto the intermediate transfer belt 25 in the pressure-contact portion between the photoreceptor drum 11 and the intermediate transfer roller 28, and by the intermediate transfer belt 25 rotating in the arrow B direction, the transferred toner image is conveyed to the transfer nip portion where the toner image is transferred onto the recording medium.

The fixing section 4 is provided downstream of the transfer section 3 along a conveyance direction of the recording medium, and contains a fixing roller 31 and a pressure roller 32. The fixing roller 31 can rotate by a drive mechanism (not shown), and heats the toner constituting an unfixed toner image carried on the recording medium so that the toner is fused to be fixed on the recording medium. Inside the fixing roller 31 is provided a heating portion (not shown). The heating portion heats the heating roller 31 so that a surface of the heating roller 31 has a predetermined temperature (heating temperature). For the heating portion, a heater, a halogen lamp, and the like device can be used, for example. The heating portion is controlled by a fixing condition controlling portion. In the vicinity of the surface of the fixing roller 31 is provided a temperature detecting sensor which detects a surface temperature of the fixing roller 31. A result detected by the temperature detecting sensor is written to a memory portion of the control unit.

The pressure roller 32 is disposed in pressure-contact with the fixing roller 31, and supported so as to be rotatably driven by the rotation of the fixing roller 31. The pressure roller 32 helps the toner image to be fixed onto the recording medium by pressing the toner and the recording medium when the toner is fused to be fixed on the recording medium by the fixing roller 31. A pressure-contact portion between the fixing roller 31 and the pressure roller 32 is a fixing nip portion.

In the fixing section 4, the recording medium onto which the toner image has been transferred in the transfer section 3 is nipped by the fixing roller 31 and the pressure roller 32 so that when the recording medium passes through the fixing nip portion, the toner image is pressed and thereby fixed onto the recording medium under heat, whereby an image is formed.

The recording medium feeding section 5 includes an automatic paper feed tray 35, a pickup roller 36, conveying rollers 37, registration rollers 38, and a manual paper feed tray 39. The automatic paper feed tray 35 is disposed in a vertically lower part of the image forming apparatus 1 and in form of a container-shaped member for storing the recording mediums. Examples of the recording medium include plain paper, color copy paper, sheets for overhead projector, and postcards. The pickup roller 36 takes out sheet by sheet the recording mediums stored in the automatic paper feed tray 35, and feeds the recording mediums to a paper conveyance path S1. The conveying rollers 37 are a pair of roller members disposed in pressure-contact with each other, and convey the recording medium to the registration rollers 38. The registration rollers 38 are a pair of roller members disposed in pressure-contact with each other, and feed to the transfer nip portion the recording medium fed from the conveying rollers 37 in synchronization with the conveyance of the toner image carried on the intermediate transfer belt 25 to the transfer nip portion. The manual paper feed tray 39 is a device for storing recording mediums which are different from the recording mediums stored in the automatic paper feed tray 35 and may have any size and which are to be taken into the image forming apparatus 1. The recording medium taken in from the manual paper feed tray 39 passes through a paper conveyance path S2 by use of the conveying rollers 37, thereby being fed to the registration rollers 38. In the recording medium feeding section 5, the recording medium supplied sheet by sheet from the automatic paper feed tray 35 or the manual paper feed tray 39 is fed to the transfer nip portion in synchronization with the conveyance of the toner image carried on the intermediate transfer belt 25 to the transfer nip portion.

The discharging section 6 includes the conveying rollers 37, discharging rollers 40, and a catch tray 41. The conveying rollers 37 are disposed downstream of the fixing nip portion along the paper conveyance direction, and convey toward the discharging rollers 40 the recording medium onto which the image has been fixed by the fixing section 4. The discharging rollers 40 discharge the recording medium onto which the image has been fixed, to the catch tray 41 disposed on a vertically upper surface of the image forming apparatus 1. The catch tray 41 stores the recording medium onto which the image has been fixed.

A control unit (not shown) is included in the dry process image forming apparatus 1. The control unit is disposed, for example, in an upper part of an internal space of the dry process image forming apparatus 1, and contains a memory portion, a computing portion, and a control portion. To the memory portion of the control unit are inputted, for example, various set values obtained by way of an operation panel (not shown) disposed on the upper surface of the dry process image forming apparatus 1, results detected from a sensor (not shown) etc. disposed in various portions inside the dry process image forming apparatus 1, and image information obtained from an external equipment. Further, programs for operating various functional elements are written. Examples of the various functional elements include a recording medium determining portion, an attachment amount controlling portion, and a fixing condition controlling portion. For the memory portion, those customarily used in the relevant filed can be used including, for example, a read only memory (ROM), a random access memory (RAM), and a hard disk drive (HDD).

For the external equipment, it is possible to use electrical and electronic devices which can form or obtain the image information and which can be electrically connected to the dry process image forming apparatus. Examples of the external equipment include a computer, a digital camera, a television receiver, a video recorder, a DVD recorder, an HDDVD, a Blu-ray disc recorder, a facsimile machine, and a mobile computer.

The computing portion of the control unit takes out the various data (such as an image formation order, the detected result, and the image information) written in the memory portion and the programs for various functional elements, and then makes various determinations. The control portion of the control unit sends to a relevant device a control signal in accordance with the result determined by the computing portion, thus performing control on operations. The control portion and the computing portion include a processing circuit which is achieved by a microcomputer, a microprocessor, etc. having a central processing unit. The control unit contains a main power source as well as the above-stated processing circuit. The power source supplies electricity to not only the control unit but also respective devices provided inside the dry process image forming apparatus.

(2) Wet Process Image Forming Apparatus

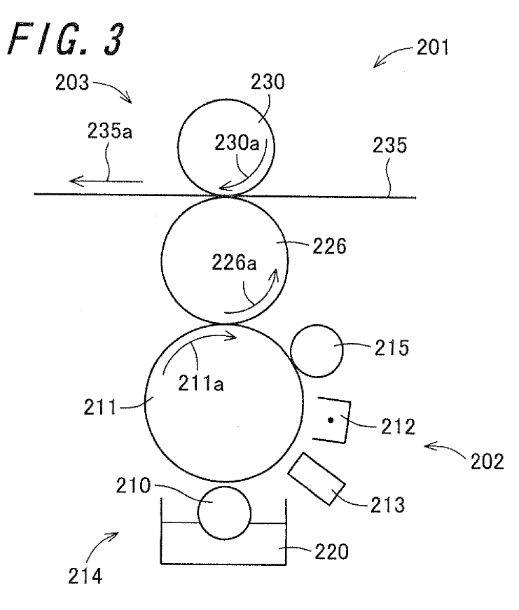

A wet toner containing spherical particles according to the second embodiment of the invention may be used in for example a wet process image forming apparatus 201 shown in FIG. 3. FIG. 3 is a schematic sectional view schematically showing a configuration of a wet process image forming apparatus 201 according to a sixth embodiment of the invention. The image forming apparatus 201 includes a photoreceptor drum 211, a charging device 212, a toner image forming section 202, a developing device 214, a transfer device 203 and a cleaning roller 215. The photoreceptor drum 211 corresponds to an image bearing member.

The toner image forming section 202, the developing device 214, the transfer device 203 and the cleaning roller 215 are disposed around the photoreceptor drum 211 in this order. The photoreceptor drum 211 is disposed rotatable in a clockwise direction shown by an arrow mark 211a by use of a driving mechanism (not shown). Owing to the rotational movement, an image bearing surface on a surface of the photoreceptor drum 211 bearing an electrostatic latent image or toner image moves relatively to the cleaning roller 215, the toner image forming section 202, the developing device 214 and the transfer device 203.

The photoreceptor drum 211 includes a base material having an electroconductive surface and a photoconductor layer formed on the electroconductive surface. The photoconductor layer contains a material that causes a variation in a charging state by irradiation with light such as an amorphous silicon photosensitive material. The photoconductor layer is charged in positive polarity by use of a charging device 212 described below. Furthermore, the photoconductor layer may be covered with a release layer (not shown).

The toner image forming section 202 includes a charge removing device (not shown), a charging device 212 and a writing device 213.

The charge removing device uniformly removes charges from a portion located in front of the charge removing device of a photoconductor layer of the photoreceptor drum 211. That is, the charge removing device eliminates an electrostatic latent image from the photoconductor layer after the transfer step.

The charging device 212 is a corona charger typical in, for example, a corotoron charger and a scorotoron charger. The charging device 212 uniformly charges in positive polarity a portion located in front of the charging device 212 of a photoconductor layer of the photoreceptor drum 211.

The writing device 213 includes a light source such as a laser exposure device or LED and an optical system that guides light irradiated from the light source to a photoconductor layer. The writing device 213 irradiates light to the photoconductor layer corresponding to image information to remove charges from a light-irradiated portion of the photoconductor layer. Thereby, an electrostatic latent image constituted of an irradiated portion that is a low potential portion and a non-irradiated portion that is a high potential portion is obtained.

The developing device 214 feeds a wet toner of the invention to an image bearing surface of the photoreceptor drum 211. The developing device 214 includes, for example, a container 220 accommodating a wet toner, a developing roller 210 disposed rotatably with a gap slightly separated from an image bearing surface, a rotation mechanism (not shown) that rotates the developing roller 210 in an anti-clockwise direction in the drawing and a voltage application mechanism (not shown) that applies a voltage to the developing roller 210.

When the developing roller 210 is rotated in an anticlockwise direction in the drawing, a toner layer made of a wet toner may be formed between the developing roller 210 and the photoreceptor drum 211. At that time, a potential of the developing roller 210 is set at a potential between a surface potential in the irradiated portion of the photoreceptor drum 211 and a surface potential in a non-irradiated portion. When the potential is set thus, positively charged toner particles in the toner layer formed between the developing roller 210 and the photoreceptor drum 211 move toward a light-irradiated portion of the photoreceptor drum. As the result, on an image bearing surface of the photoreceptor drum 211, a toner image with a pattern corresponding to the electrostatic latent image is formed.

The transfer device 203 includes an intermediate transfer roller 226 and a backup roller 230. The transfer device 203 transfers a toner image on a surface of the photoreceptor drum 211 via the intermediate transfer roller 226 on a recording medium 235. When a toner image is transferred from the photoreceptor drum 211 to the Intermediate transfer roller 226, the transfer device 203 makes use of pressure when the photoreceptor drum 211 and the intermediate transfer roller 226 are brought into pressure contact. When a toner image is transferred from the intermediate transfer roller 226 to a recording medium 235 such as a paper sheet and an OHP sheet, pressure when the intermediate transfer roller 226 and the backup roller 230 are brought into pressure contact is made use of.

The intermediate transfer roller 226 is pressed against the photoreceptor drum 211 so that a transfer surface of the intermediate transfer roller may come into contact with an image bearing surface of the photoreceptor drum 211. The intermediate transfer roller 226 rotates in a direction of an arrow mark 226a as the photoreceptor drum 211 rotates.

In the backup roller 230, a pressure surface thereof is pressed against the intermediate transfer roller 226 so as to come into contact through a recording medium 235 with a transfer surface of the intermediate transfer roller 226. The backup roller 230 rotates in a direction of an arrow mark 230a as the intermediate transfer roller 226 rotates.

The transfer device 203 may further contain a heater. That is, the transfer device 203 may be constituted so that pressure and heat may be utilized when a toner image is transferred from the photoreceptor drum 211 to the intermediate transfer roller 226 and when a toner image is transferred from the intermediate transfer roller 226 to the recording medium 235. Furthermore, the transfer device 203 may include a transfer mechanism that moves a recording medium 235 in a direction of an arrow 235a.

The intermediate transfer roller 226 may be an intermediate transfer belt.

The cleaning roller 215 removes toner remaining on an image bearing surface after transfer.

When a developer according to a fourth embodiment of the invention is used to form images, stable and high-quality images are obtained.

The image forming apparatuses 1 and 201 according to the fifth and sixth embodiments of the invention are realized by including photoreceptor drums 11 and 211 on which an electrostatic latent image is to be formed, toner image forming sections 2 and 202 by which an electrostatic latent image is formed on the photoreceptor drums 11 and 211, and developing devices 14 and 214 capable of forming a toner image on the photoreceptor drums 11 and 211. When an image is formed by use of an image forming apparatus like this, high-quality images are stably formed.

The respective physical properties in examples and comparative examples are measured as shown below.

### [Volume Average Particle Size Dv and Coefficient of Variation CV of Spherical Particles]

Sample particles were poured in an aqueous solution containing FAMILY FRESH (trade name, manufactured by Kao Corporation) and agitated to inhibit the spherical particles that are sample particles from aggregating, followed by charging the aqueous solution containing the sample particles in a laser diffraction/scattering particle size distribution analyzer (trade name: MICROTRACK MT3000, manufactured by Nikkiso Co., Ltd.), further followed by measuring twice a volume particle size distribution of the sample particles under conditions shown below, and a volume particle size distribution was obtained as an average thereof. The measurement conditions were set to a measuring time: 30 sec, the refractive index of particles: 1.4, particle shape: non-spherical, solvent: water, and refractive index of solvent: 1.33. After the average volume particle size distribution of the sample particles was obtained, based on the measurement results, a particle size at which a cumulative volume from a small particle size side in a cumulative volume particle size distribution becomes 50% was calculated as a volume average particle size Dv (μm) of the spherical particles. Furthermore, the standard deviation (μm) in the volume particle size distribution was obtained and the coefficient of variation CV (%) was calculated based on the expression (1) below. The coefficient of variation means that the smaller a value thereof is, the narrower the width of particle size distribution is.

Coefficient of variation CV(%)={(Standard deviation of volume particle size distribution)/(Volume average particle sizes)}×100 (1)

A volume average particle size and the coefficient of variation CV of capsule particles as well were obtained similarly.

[Average Sphericity of Spherical Particles]

A dispersion liquid was prepared by dispersing 5 mg of the spherical particles in 10 mL of water in which substantially 0.1 mg of a surfactant is dissolved, followed by irradiating an ultrasonic wave of a frequency of 20 kHz and an output of 50 W to the dispersion liquid for 5 min, a concentration of the spherical particles in the dispersion liquid is set at 5000 to 20,000 particles/μL, followed by measuring the sphericity (ai) based on an expression (3) below by use of a flow type particle image analyzer FPIA-3000 (trade name, manufactured by Sysmex Co., Ltd.). A sum total of the respective sphericities (ai) measured of m pieces of the toner particles was obtained, and an arithmetic average value obtained by the expression (2) where the sum total is divided by the number of toner particles m is calculated as an average sphericity (a).

Sphericity (ai)=(circumferential length of a circle having a projection area same as a particle image)/(length or a circumference of a projected image of a particle) (3)

$$Average sphericity ( a ) = {\sum }_{i = 1}^{m} ai / m \qquad ( 2 )$$

[Glass Transition Temperature of Binder Resin]

by using a differential scanning calorimeter (trade name of products: DSC 220, manufactured by Seiko Instruments & Electronics Ltd.), 1 g of the binder resin as the specimen was heated at a temperature elevation rate of 10° C. per minute according to (JIS) K 7121-1987 to measure a DSC curve. A temperature at an intersection between a line extended from a base line on the high temperature side of an endothermic peak corresponding the glass transition of the obtained DSC curve to the low temperature side and a tangential line drawn at a point to maximize the gradient to the curve from the rising part to the top of the peak was defined as the glass transition temperature (Tg) of the binder resin.

[Softening Temperature of Binder Resin]

The softening temperature of the binder resin was measured by using a flowing characteristic evaluation apparatus (trade name of products: Flow Tester CFT-100C, manufactured by Shimadzu Corporation). In the flowing characteristic evaluation apparatus (Flow Tester CFT-100C), setting was made such that 1 g of the binder resin as the specimen was extruded from a die (nozzle: 1 mm diameter, 1 mm length) by applying a load of 10 kgf/cm² (9.8×10⁵ Pa), heating was conducted at a temperature elevation rate of 6° C. per minute, and the temperature at which a one-half amount of the specimen was discharged from the die was determined and defined as a softening temperature of the binder resin.

[Molecular Weight and Molecular Weight Distribution Index (Mw/Mn) of Binder Resin]

A GPC unit (trade name: HLC-8220GPC, manufactured by Tosoh Corporation) was used. A 0.253 by weight tetrahydrofuran (hereinafter referred to as THF) solution of a sample was prepared as a sample solution at 40° C. A charging amount of the sample solution was set at 200 μL and a molecular weight distribution curve was obtained. A molecular weight at a summit of a peak of the resulted molecular weight distribution curve was obtained as a peak top molecular weight. Furthermore, from the resulted molecular weight distribution curve, a weight average molecular weight Mw and a number average molecular weight Mn were obtained, and therefrom a molecular weight distribution index (Mw/Mn; hereinafter, simply referred to as “Mw/Mn”) that is a ratio of the weight average molecular weight Mw to the number average molecular weight Mn was obtained. A molecular weight calibration curve was prepared with standard polystyrene.

[Melting Temperature of Release Agent]

A differential scanning calorimeter (DSC220, trade name of products manufactured by Seiko Instruments & Electronics Ltd.) was used and a procedure of elevating the temperature of 1 g of the release agent from 20° C. to 200° C. at a temperature elevation rate of 10° C. per minute and then rapidly cooling from 200° C. to 20° C. was repeated twice to measure the DSC curve. The temperature at the apex of an endothermic peak corresponding to the melting on the DSC curve measured by the second operation was determined as a melting temperature for the release agent.

### Example 1

### Coarse Particle Preparation Step t1

A mixture of 92.5 parts by weight of polyester (binder resin, glass transition temperature Tg: 58° C., weight average molecular weight Mn: 80,000, weight average molecular weight (Mw)/number average molecular weight (Mn)=24, softening temperature: 120° C.), 6 parts by weight of copper phthalocyanine blue (colorant), 1.5 parts by weight of a charge control agent (trade name: TRH, manufactured by Hodogaya Chemical Co., Ltd.) and 2.0 parts by weight of ester wax (release agent, trade name: WEP-8, manufactured by Nippon Oil & Pats Co., Ltd.) was melt-kneaded at a cylinder temperature of 145° C. and a barrel rotation number of 300 rpm by use of a biaxial extruder (trade name: PCM-30, manufactured by Ikegai, Ltd.) and thereby a melted and kneaded product of the binder resin was prepared. The melted and kneaded product was cooled to room temperature and coarsely pulverized by means of a cutter mill (trade name: VM-16, manufactured by Orient Co., Ltd.), and thereby coarse resin particles having a particle size from 100 to 500 μm were prepared.

[Dispersion Liquid Preparation Step t2]

Then, 94 parts by weight of the resin coarse particles obtained in the step of preparation of coarse particles t1 and 20 parts by weight of a 30% by weight aqueous solution of a dispersion stabilizer (trade name: JONCRYL 70, manufactured by Johnson Polymer Corporation) were mixed to prepare a dispersion liquid of the resin coarse particles. The dispersion liquid of the resin coarse particles was pre-treated by passing through a nozzle having an inner diameter of 0.45 mm under pressure of 168 MPa, and thereby a particle size of the resin coarse particles in the dispersion liquid of the resin coarse particles was controlled to 100 μm or less.

Pulverizing Step t3

The dispersion liquid of resin coarse particles obtained in the dispersion liquid preparation step t2 was heated and pressurized at process pressure of 168 MPa and a process temperature of 150° C. in a pressure resistant hermetically seated container and fed from a pressure-resistant piping attached to the pressure-resistant hermetically sealed container to a pressure-resistant nozzle attached to an outlet of the pressure-resistant piping. At that time, the viscosity of the dispersion liquid of resin coarse particles was 5000 cP or less. The pressure-resistant nozzle is a pressure-resistant nozzle having a length of 1 mm in which one liquid flow hole having a hole diameter of 0.06 mm is formed in a longitudinal direction of the nozzle. At the outlet of the pressure-resistant nozzle, pressure of 33 MPa was applied to the dispersion liquid of resin coarse particles.

[Cooling Step t4]

The dispersion liquid of the spherical particles discharged from a pressure-resistant nozzle was guided to a corrugated tube cooler connected to an outlet of the pressure-resistant nozzle to cool the dispersion liquid of spherical particles. A temperature of the dispersion liquid of spherical particles at the outlet of the corrugated tube cooler was 30° C. and pressure applied to the dispersion liquid of spherical particles was 18 MPa.

[Depressurizing Step t5]

The dispersion liquid of spherical particles discharged from the outlet of the corrugated tube cooler was guided to a multistage depressurizing apparatus connected to the outlet of the corrugated tube cooler to depressurize the dispersion liquid of spherical particles. The dispersion liquid of spherical particles discharged from the multistage depressurizing apparatus was thoroughly washed with ion-exchanged water and dried, and thereby spherical particles of Example 1 were obtained. The spherical articles of Example 1 had a volume average particle size of 0.91 μm and the coefficient of variation CV of 20%.

### Example 2

Spherical particles of Example 2 were obtained in a manner similar to Example 1 except that a polyester resin having the glass transition temperature of 63° C. and the weight average molecular weight of 28,000 was used in place of the polyester resin used in Example 1 and, in the pulverizing step t3, a treatment temperature was changed from 150° C. to 200° C. The spherical particles of Example 2 had a volume average particle size of 1.31 μm and the coefficient of variation CV of 19%.

### Example 3

Spherical particles of Example 3 were obtained in a manner similar to Example 1 except that a polyester resin having the glass transition temperature of 63° C. and the weight average molecular weight of 28,000 was used in place of the polyester resin used in Example 1 and, in the pulverizing step t3, treatment pressure was changed from 168 MPa to 116 MPa and the treatment temperature was changed from 10° C. to 200° C. The spherical particles of Example 3 had a volume average particle size of 1.82 μm and the coefficient of variation CV of 20%.

### Example 4

Spherical particles of Example 4 were obtained in a manner similar to Example 1 except that a polyester resin having the glass transition temperature of 56° C. and the weight average molecular weight of 16,000 was used in place of the polyester resin used in Example 1, the release agent was not contained, and, in the pulverizing step t3, a treatment temperature was changed from 150° C. to 110° C. The spherical particles of Example 4 had a volume average particle size of 0.82 μm and the coefficient of variation CV of 18%.

### Example 5

Spherical particles of Example 5 were obtained in a manner similar to Example 1 except that an acrylic resin having the glass transition temperature of 62° C. and the weight average molecular weight of 30,000 was used in place of the polyester resin used in Example 1 and, in the pulverizing step t3, treatment pressure was changed from 168 MPa to 116 MPa and the treatment temperature was changed from 150° C. to 235° C. The spherical particles of Example 5 had a volume average particle size of 0.12 μm and the coefficient of variation CV of 15%.

### Example 6

Spherical particles of Example 6 were obtained in a manner similar to Example 1 except that, in the pulverizing step t3, the treatment temperature was changed from 150° C. to 200° C. The spherical particles of Example 6 had a volume average particle size of 0.42 μm and the coefficient of variation CV of 17%.

### Example 7

Spherical particles of Example 7 were obtained in a manner similar to Example 1 except that an acrylic resin having the glass transition temperature of 62° C. and the weight average molecular weight of 30,000 was used in place of the polyester resin used in Example 1 and, in the pulverizing step t3, the treatment temperature was changed from 150° C. to 200° C. The spherical particles of Example 7 had a volume average particle size of 0.49 μm and the coefficient of variation CV of 18%.

### Example 8

Spherical particles of Example 8 were obtained in a manner similar to Example 1 except that an epoxy resin having the glass transition temperature of 56° C. and the weight average molecular weight of 15,000 was used in place of the polyester resin used in Example 1, a release agent having a melting temperature 110° C. was used in place of the release agent used in Example 1, and, in the pulverizing step t3, the treatment temperature was changed from 150° C. to 200° C. The spherical particles of Example 8 had a volume average particle size of 0.21 μm and the coefficient of variation CV of 17%.

### Example 9

Spherical particles of Example 9 were obtained in a manner similar to Example 1 except that, in the pulverizing step t3, treatment pressure was changed from 168 MPa to 210 MPa and the treatment temperature was changed from 150° C. to 190° C. The spherical particles of Example 9 had a volume average particle size of 0.54 μm and the coefficient of variation CV of 18%.

### Example 10

Spherical particles of Example 10 were obtained in a manner similar to Example 1 except that a polyester resin having the glass transition temperature of 63° C. and the weight average molecular weight of 28,000 was used in place of the polyester resin used in Example 1 and, in the pulverizing step t3, the treatment temperature was changed from 150° C. to 200° C. The spherical particles of Example 10 had a volume average particle size of 1.31 μm and the coefficient of variation CV of 19%.

### Example 11

Spherical particles of Example 11 were obtained in a manner similar to Example 1 except that a polyester resin having the glass transition temperature of 63° C. and the weight average molecular weight of 28,000 was used in place of the polyester resin used in Example 1, a release agent having the melting temperature of 45° C. was used in place of the release agent used in Example 1, and, in the pulverizing step t3, the temperature was changed from 150° C. to 200° C. The spherical particles of Example 11 had a volume average particle size of 1.10 μm and the coefficient of variation CV of 19%.

### Example 12

Spherical particles of Example 12 were obtained in a manner similar to Example 1 except that a polypropylene resin having the glass transition temperature of 57° C. and the weight average molecular weight of 30,000 was used in place of the polyester resin used in Example 1 and the release agent, the colorant and the charge control agent were not contained. The spherical particles of Example 12 had a volume average particle size of 0.43 μm and the coefficient of variation CV of 20%.

### Example 13

Spherical particles of Example 13 were obtained in a manner similar to Example 1 except that a polyester resin having the glass transition temperature of 48° C. and the weight average molecular weight of 9,000 was used in place of the polyester resin used in Example 1. The spherical particles of Example 13 had a volume average particle size of 0.72 μm and the coefficient of variation CV of 18%.

### Example 14

Spherical particles of Example 14 were obtained in a manner similar to Example 1 except that a release agent having the melting temperature of 121° C. was used in place of the release agent used in Example 1 and, in the pulverizing step t3, the treatment temperature was changed from 150° C. to 180° C. The spherical particles of Example 14 had a volume average particle size of 1.36 μm and the coefficient of variation CV of 20%.

### Example 15

Spherical particles of Example 15 were obtained in a manner similar to Example 2 except that a polyester resin having the glass transition temperature of 66° C. and the weight average molecular weight of 310,000 was used in place of the polyester resin used in Example 2. The spherical particles of Example 15 had a volume average particle size of 1.12 μm and the coefficient of variation CV of 20%.

### Example 16

Spherical particles of Example 16 were obtained in a manner similar to Example 1 except that a polyester resin having the glass transition temperature of 39° C. and the weight average molecular weight of 9,500 was used in place of the polypropylene resin used in Example 12 and the release agent, the colorant and the charge control agent were not contained. The spherical particles of Example 16 had a volume average particle size of 0.23 μm and the coefficient of variation CV of 18%.

### Example 17

Spherical particles of Example 17 were obtained in a manner similar to Example 15 except that a polyester resin having the glass transition temperature of 72° C. and the weight average molecular weight of 310,000 was used in place of the polyester resin used in Example 15. The spherical particles of Example 17 had a volume average particle size of 1.51 μm and the coefficient of variation CV of 20%.

### Comparative Example 1

### Coarse Particle Preparation Step t1

A mixture of 100 parts by weight of titanium oxide powder and 600 parts by weight of water was treated for 30 min by use of a colloid mill (manufactured by PUC, clearance: 100 μm) to prepare a dispersion liquid.

Dispersion Liquid Preparation Step t2)

Then, 94 parts by weight of the dispersion liquid obtained in the step of preparation of coarse particles t1 and 20 parts by weight of a 30% by weight aqueous solution of a dispersion stabilizer (trade name: JONCRYL 70, manufactured by Johnson Polymer Corporation) were mixed to prepare a dispersion liquid of titanium oxide coarse particles. The dispersion liquid of the titanium oxide coarse particles was pre-treated by passing through a nozzle having an inner diameter of 0.45 mm under pressure of 168 MPa, and thereby a particle size of the titanium oxide coarse particles in the dispersion liquid of the titanium oxide coarse particles was controlled to 100 μm or less.

[Pulverizing Step t3]

The dispersion liquid of titanium oxide coarse particles obtained in the dispersion liquid preparation step t2 was heated and pressurized at process pressure of 168 MPa and a process temperature of 200° C. in a pressure resistant hermetically sealed container and fed from a pressure-resistant piping attached to the pressure-resistant hermetically sealed container to a pressure-resistant nozzle attached to an outlet of the pressure-resistant piping. At that time, the viscosity of the dispersion liquid of titanium oxide coarse particles was 5000 cP or less. The pressure-resistant nozzle is a pressure-resistant nozzle having a length of 1 mm in which a liquid flow hole having a hole diameter of 0.06 mm is formed in a longitudinal direction of the nozzle. At the outlet of the pressure-resistant nozzle, pressure of 33 MPa was applied to the dispersion liquid of titanium oxide coarse particles.

[Cooling Step t4]

The dispersion liquid of the spherical particles discharged from a pressure-resistant nozzle was guided to a corrugated tube cooler connected to an outlet of the pressure-resistant nozzle to cool the dispersion liquid of spherical particles. A temperature of the dispersion liquid of spherical particles at the outlet of the corrugated tube cooler was 30° C. and pressure applied to the dispersion liquid of spherical particles was 18 MPa.

[Depressurizing Step t5]

The dispersion liquid of spherical particles discharged from the outlet of the corrugated tube cooler was guided to a multistage depressurizing apparatus connected to the outlet of the corrugated tube cooler to depressurize the dispersion liquid of spherical particles. The dispersion liquid of spherical particles discharged from the multistage depressurizing apparatus was thoroughly washed with ion-exchanged water and dried, and thereby spherical particles of Comparative Example 1 were obtained. The spherical particles of Comparative Example 1 had a volume average particle size of 0.42 μm and the coefficient of variation CV of 17%.

### Comparative Example 2

Spherical particles of Comparative Example 2 were obtained in a manner similar to Example 1 except that a preset temperature was changed from 200° C. to 240° C. in the pulverizing step t3 and the stepwise pressure release was not performed in the depressurizing step t5. The spherical particles of Comparative Example 2 had a volume average particle size of 40 μm and the coefficient of variation of 86%.

### Comparative Example 3

Spherical particles of Comparative Example 3 were obtained in a manner similar to Example 1 except that a polyester resin having the glass transition temperature of 58° C. and the weight average molecular weight of 62,000 was used in place of the polyester resin used in Example I and, in the pulverizing step t3, a treatment temperature was changed from 150° C. to 110° C. The spherical particles of Comparative Example 3 had a volume average particle size of 130 μm and the coefficient of variation CV of 105%. The spherical particles were too large in the volume average particle size and coefficient of variation CV to use as toner and other applications.

[Preparation of Capsule Particles]

With 100 parts by weight of each of the dispersion liquids of spherical particles of Examples 10 and 11 before cleaning with ion exchanged water agitating at 80° C., 10 parts by weight of the dispersion liquid of spherical particles of Example 5 before cleaning with ion exchanged water and 1 part by weight of saturated sodium chloride were separately added to each of the dispersion liquids of spherical particles of Examples 10 and 11, followed by agitating for 3 hours, thereby capsule particles where a core material was formed of each of spherical particles of Examples 10 and 11 and a shell material was formed of spherical particles of Example 5 were prepared.

[Preparation of Wet Developer]

To 3 parts by weight of spherical particles obtained in each of Examples 1 through 4, 13 through 15 and Comparative Example 2, and to 3 parts by weight of capsule particles containing the spherical particles of each of Examples 10 and 11, 97 parts by weight of ISOPER L (trade name, manufactured by Showa Shell Sekiyu K. K.) were added and adapted well, thereby wet developers containing spherical particles obtained in each of Examples 1 through 4, 13 through 15 and Comparative Example 2 and capsule particles containing the spherical particles of each of Examples 10 and 11 were obtained.

[Preparation of Dry Developer]

To 100 parts by weight of spherical particles obtained in each of Examples 1 through 4, 13 through 15 and Comparative Example 2, and to 100 parts by weight of capsule particles containing the spherical particles of each of Examples 10 and 11, 15 parts by weight of silica fine particles (trade name: R972, manufactured by Nippon Aerosil Co., Ltd.) were externally added as an external additive, thereby dry developers containing each of spherical particles obtained in Examples 1 through 4, 13 through 15 and Comparative Example 2 and capsule particles containing the spherical particles of Examples 10 and 11 were prepared.

Of Examples 1 through 17 and Comparative Examples 1 through 3, kinds of materials to be treated, physical properties of the binder resins and release agents, and producing conditions of the spherical particles are shown in Table 1.

TABLE 1

| | | Physical Properties | | | Producing Conditions | | | | |
|---|---|---|---|---|---|---|---|---|---|
| | | of Binder Resin | | | of Spherical Particles | | | | |
| | | | Weight | Release | | | | Temperature at | |
| | | Glass | Average | agent | | | | the time-point of | Melt Viscosity |
| | | Transition | Molecular | Melting | Stepwise | Process | Process | going past | at the time-point |
| | Material to be | Temperature | Weight | Temperature | Pressure | Pressure | Temperature | Nozzle Portion | of going past |
| | treated | Tg (° C.) | Mw (×10³) | (° C.) | Release | (MPa) | (° C.) | (° C.) | Nozzle Portion (cP) |
| Ex. 1 | Polyester Resin | 58 | 21 | 85 | Yes | 168 | 150 | 180 | 1980 |
| Ex. 2 | Polyester Resin | 63 | 28 | 85 | Yes | 168 | 200 | 230 | 2350 |
| Ex. 3 | Polyester Resin | 63 | 28 | 85 | Yes | 116 | 200 | 210 | 3250 |
| Ex. 4 | Polyester Resin | 56 | 16 | — | Yes | 168 | 110 | 140 | 1260 |
| Ex. 5 | Acrylic Resin | 62 | 30 | 85 | Yes | 116 | 235 | 245 | 235 |
| Ex. 6 | Polyester Resin | 58 | 21 | 85 | Yes | 168 | 200 | 230 | 540 |
| Ex. 7 | Acrylic Resin | 62 | 30 | 85 | Yes | 168 | 200 | 230 | 975 |
| Ex. 8 | Epoxy Resin | 56 | 15 | 110 | Yes | 168 | 200 | 230 | 320 |
| Ex. 9 | Polyester Resin | 58 | 21 | 85 | Yes | 210 | 190 | 230 | 950 |
| Ex. 10 | Polyester Resin | 63 | 28 | 85 | Yes | 168 | 200 | 230 | 2350 |
| Ex. 11 | Polyester Resin | 63 | 28 | 45 | Yes | 168 | 200 | 230 | 1990 |
| Ex. 12 | Polypropylene | 57 | 30 | — | Yes | 168 | 150 | 180 | 1680 |
| Ex. 13 | Polyester Resin | 48 | 9 | 85 | Yes | 168 | 150 | 180 | 1210 |
| Ex. 14 | Polyester Resin | 58 | 21 | 121 | Yes | 168 | 180 | 210 | 1980 |
| Ex. 15 | Polyester Resin | 66 | 310 | 85 | Yes | 168 | 200 | 230 | 2350 |
| Ex. 16 | Polyester Resin | 39 | 9.5 | — | Yes | 168 | 150 | 180 | 210 |
| Ex. 17 | Polyester Resin | 72 | 310 | — | Yes | 168 | 220 | 250 | 4230 |
| Comp. Ex. 1 | Titanium Oxide | — | — | — | Yes | 168 | 200 | 230 | >5000 |
| Comp. Ex. 2 | Polyester Resin | 58 | 21 | 85 | No | 168 | 200 | 230 | 1980 |
| Comp. Ex. 3 | Polyester Resin | 58 | 62 | 85 | Yes | 168 | 110 | 140 | >5000 |

Particle size distributions, average sphericities and applications of the spherical particles obtained in each of Examples 1 through 17 and Comparative Examples 1 through 3 and a particle size distribution of the capsule particles are shown in Table 2. In the average sphericity, “>0.98” means that the average sphericity exceeds 0.98.

TABLE 2

| | Spherical Particles | | | | Capsule Particles | | | |
|---|---|---|---|---|---|---|---|---|
| | Volume | | | | | | Particle Size Distribution of | |
| | Average | Coefficient | | | | Addition Ratio | Capsule Particles | |
| | Particle | of Variation | Average | | | of Spherical | Volume Average | Coefficient of |
| | Size (μm) | CV | Sphericity | Applications | Shell Material | particles | Particle Size (μm) | variation CV |
| Ex. 1 | 0.91 | 20 | >0.98 | Toner | — | — | — | — |
| Ex. 2 | 1.31 | 19 | >0.98 | Toner | — | — | — | — |
| Ex. 3 | 1.82 | 20 | >0.98 | Toner | — | — | — | — |
| Ex. 4 | 0.82 | 18 | >0.98 | Toner | — | — | — | — |
| Ex. 5 | 0.12 | 15 | >0.98 | Shell | — | — | — | — |
| Ex. 6 | 0.42 | 17 | >0.98 | Paint | — | — | — | — |
| Ex. 7 | 0.49 | 18 | >0.98 | Paint | — | — | — | — |
| Ex. 8 | 0.21 | 17 | >0.98 | Paint | — | — | — | — |
| Ex. 9 | 0.54 | 18 | >0.98 | Paint | — | — | — | — |
| Ex. 10 | 1.31 | 19 | >0.98 | Toner Base particle | Spherical Particles | 10% | 1.53 | 18 |
| | | | | | of Example 5 | | | |
| Ex. 11 | 1.10 | 19 | >0.98 | Toner Base particle | Spherical Particles | 40% | 1.49 | 20 |
| | | | | | of Example 5 | | | |
| Ex. 12 | 0.43 | 20 | >0.98 | Surface Coating Agent | — | — | — | — |
| Ex. 13 | 0.72 | 18 | >0.98 | Toner | — | — | — | — |
| Ex. 14 | 1.36 | 20 | >0.98 | Toner | — | — | — | — |
| Ex. 15 | 1.12 | 20 | >0.98 | Toner | — | — | — | — |
| Ex. 16 | 0.23 | 18 | >0.98 | Surface Coating Agent | — | — | — | — |
| Ex. 17 | 1.51 | 20 | >0.98 | Lubricant | — | — | — | — |
| Comp. Ex. 1 | 0.42 | 17 | 0.65 | Paint | — | — | — | — |
| Comp. Ex. 2 | 40 | 86 | 0.86 | Toner | — | — | — | — |
| Comp. Ex. 3 | 130 | 105 | 0.65 | — | — | — | — | — |

A dry developer containing each of spherical particles obtained in Examples 1 through 4, 13 through 15 and Comparative Example 2 and capsule particles containing the spherical particles of Examples 10 and 11 was charged in a copy machine obtained by modifying a commercially available wet type copy machine, and the image quality and fixability were evaluated with the copy machine according to methods shown below. In the evaluation, a toner amount of an image formed on a recording medium was controlled so as to be 0.3 mg/cm².

[Image Quality]

A wet developer containing each of spherical particles obtained in Examples 1 through 4, 13 through 15 and Comparative Example 2 and capsule particles containing the spherical particles of Examples 10 and 11 was charged in an evaluation machine obtained by modifying a copy machine (trade name: AR-C150, manufactured by Sharp Corporation), and the copy machine was used to copy a chart having a concentration gradation on 100,000 sheets. The 100,000-th image was taken as an evaluation image, and the granularity and gradation properties of the evaluation image were visually evaluated. Furthermore, the evaluation method may evaluate as well the cleanability of the particles and the developers. When there is no problem of the evaluation results, the cleanability of the particles and the developers may be said excellent in the cleanability.

The image quality was evaluated based on evaluation criteria shown below.

Good: No problem

Not Bad: Partial inconvenience but non-problematic level

Poor: Defect in image quality

A wet developer containing each of spherical particles obtained in Examples 1 through 4, 13 through 15 and Comparative Example 2 and capsule particles containing the spherical particles of Examples 10 and 11 was charged in a copy machine (trade name: AR-C150, manufactured by Sharp Corporation) obtained by removing an oil coating mechanism of a fixing unit, temperatures when hot offset and cold offset occurred in the copy machine were measured, and a width between a temperature where the hot offset was caused and a temperature where the cold offset was caused (hereinafter, referred to as “fixing range”) was used to evaluate the fixability.

The fixability was evaluated based on the evaluation criteria shown below.

Good: Favorable. The fixing range is 80° C. or more.

Not Bad: Acceptable. The fixing range exceeds 50° C. and is 80° C. or less.

Poor: Not acceptable. The fixing range is 50° C. or less.

Each of spherical particles obtained in Examples 1 through 4, 13 through 15 and Comparative Example 2 and capsule particles containing the spherical particles of Examples 10 and 11 was used to evaluate the storability according to a method shown below.

[Storability]

In a 500 cc toner bottle, 100 g of each of spherical particles obtained in Examples 1 through 4, 13 through 15 and Comparative Example 2 and capsule particles containing the spherical particles of Examples 10 and 11 was poured and left standstill in a thermostat set at 45° C. for 48 hours, followed by transferring each of the spherical particles and capsule particles on a mesh having an opening of 75 μm, further followed by shaking with a shaker, and an amount of each of the spherical particles and the capsule particles on the mesh (hereinafter, referred to as “remaining spherical particles and capsule particles”) was measured to evaluate the storability.

The storability was evaluated based on evaluation criteria shown below.

Good: Favorable. An amount of the remaining spherical particles and capsule particles is 0.5 g or less.

Not Bad: Acceptable. An amount of the remaining spherical particles and capsule particles exceeds 0.5 g and is less than 1.0 g.

Poor: Not acceptable. An amount of the remaining spherical particles and capsule particles is 1.0 g or more.

Evaluation results of wet developers containing each of the spherical particles obtained in Examples 1 through 4, 13 through 15 and Comparative Example 2 and capsule particles containing the spherical particles of Examples 10 and 11 are shown in Table 3.

TABLE 3

| | Image Quality | | | | | | |
|---|---|---|---|---|---|---|---|
| | After 100,000 Copy | | Fixability | | | Storability | |
| | | Evaluation of | Cold Offset | Hot Offset | | Amount of remaining | |
| | Evaluation of | Gradation | Occurrence | Occurrence | | spherical particles and | |
| | Granularity | Properties | Temperature (° C.) | Temperature (° C.) | Evaluation | capsule particles (g) | Evaluation |
| Ex. 1 | Good | Good | 130 | 210 | Good | 0.21 | Good |
| Ex. 2 | Good | Good | 130 | 210 | Good | 0.23 | Good |
| Ex. 3 | Good | Good | 130 | 210 | Good | 0.28 | Good |
| Ex. 4 | Good | Good | 120 | 170 | Not Bad | 0.30 | Good |
| Ex. 10 | Good | Good | 130 | 210 | Good | 0.24 | Good |
| Ex. 11 | Good | Good | 130 | 210 | Good | 0.26 | Good |
| Ex. 13 | Good | Good | 130 | 210 | Good | 0.28 | Good |
| Ex. 14 | Good | Good | 150 | 210 | Not Bad | 0.26 | Good |
| Ex. 15 | Good | Good | 160 | 220 | Not Bad | 0.19 | Good |
| Comp. Ex. 2 | Poor | Poor | 170 | 200 | Poor | 0.54 | Not Bad |

Each of the spherical particles obtained in Examples 6 through 9, 12, 16 and 17 and Comparative Example I was electrostatically coated on a zinc phosphate-treated steel plate (manufactured by Nippon Testpanel Co., Ltd.) with a commercially available corona discharge spray gun so that a film thickness at coating may be 20 μm or more and 40 μm or less, the coated zinc phosphate-treated steel plate was baked at 160° C. for 40 min, and thereby a test plate was obtained. The glossiness and flatness of the resulted test plate were evaluated according to methods shown below.

[Glossiness]

At five points of the test plate, the glossiness was measured with a measurement unit (Gloss meter, trade name: GMX-202 60, manufactured by Murakami Color Research Laboratory), followed by calculating an average value thereof.

[Flatness]

A test plate was observed obliquely at an angle of 30° or more and 60° or less in an enough bright room to visually observe a coated surface state of the test plate. The flatness was evaluated based on whether there are voids (orange peels) and craters that are holes on a surface of the test plate, which are caused by bubbles generated when the zinc phosphate-treated steel plate is baked, or not.

Evaluation criteria of the flatness are as shown below.

Good: Favorable. A surface of the test plate is sufficiently flat and voids are not observed.

Not Bad: Acceptable. A surface of the test plate is flat but voids are observed.

Poor: Not-acceptable Craters and voids are observed on a surface of the test plate.

Each of the spherical particles obtained in Examples 6 through 9, 12, 16 and 17 and Comparative Example 1 was used and evaluated as a paint, a surface coating agent or a lubricant and evaluation results are shown in Table 4.

TABLE 4

| | Glossiness | Flatness |
|---|---|---|
| | Value of Glossiness (%) | Evaluation |
| Ex. 6 | 95 | Good |
| Ex. 7 | 94 | Good |
| Ex. 8 | 97 | Good |
| Ex. 9 | 95 | Good |
| Ex. 12 | — | Good |
| Ex. 16 | 98 | Good |
| Ex. 17 | 94 | Not Bad |
| Comp. Ex. 1 | 88 | Poor |

As shown in Table 2, it is found that the spherical particles produced according to the producing method of the spherical particles of the invention are small in the particle size and sharp in the particle size distribution. In Comparative Example 2 where the stepwise pressure release was not performed and Comparative Example 3 where the melt viscosity at the time point of passing through the nozzle was more than 5000 cP, the particle size of the resulted spherical particles was large and the particle size distribution was broad. Since the spherical particles and toners of the invention are sharp in the particle size distribution, the capsule particles of Examples 10 and 11 where the toner of the invention is used as a core material and the spherical particles of the invention are used as a shell material are found to be sharp in the particle size distribution.

As shown in Table 3, it is found that, when the spherical particles of the invention are used as the toner, the cleaning properties, fixability and storability are excellent; as the result, images having excellent image quality may be stably formed. In Example 14 where the melting temperature of the release agent exceeded 120° C., the fixability was a little deteriorated.

In Example 13 where the binder resin having the glass transition temperature lower than other examples was used, an amount of remaining spherical particles and capsule particles Increased only a little, that is, the storability was evaluated excellent. This is because, since the glass transition temperature of the spherical particles varies depending on the kind and amount of the constituent materials, even when the glass transition temperature of the binder resin is low, the glass transition temperature of the spherical particles may be raised under influence of the melting temperature and polarity of the added materials, resulting in making the storability excellent.

As shown in Table 4, it is found that, the spherical particles produced according to the producing method of the spherical particles of the invention may be used not only as the toner but also as the paint, and an excellent effect is exhibited as a paint.

The spherical particles of Example 12 of which application is a surface coating material is found to be high in the surface flatness since the voids are not observed on a surface of the test plate. Furthermore, the spherical particles of Example 12 may be used as a toner.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A producing method of spherical particles, comprising a pulverizing step for passing a dispersion liquid of coarse particles of material to be processed, which dispersion liquid includes a polymer dispersant and the coarse particles of material to be processed dispersed in a liquid medium, through a high-pressure homogenizer having a stepwise pressure release mechanism and milling the coarse particles of material to be processed contained in the dispersion liquid under conditions where a melt viscosity of the dispersion liquid at a time point of passing the nozzle portion of the high-pressure homogenizer is 5000 cP or less.

2. A spherical particle produced by the producing method of the spherical particle of claim 1.

3. The spherical particle of claim 2, wherein its volume average particle size is 0.11 or more and 2 μm or less and a coefficient of variation CV of the volume particle size distribution represented by the following expression (1) is 20% or less:
Coefficient of variation CV(%)={(Standard deviation of volume particle size distribution)/(Volume average particle size)}×100 (1)

4. The spherical particle of claim 2, further comprising at least a resin.

5. A toner comprising the spherical particle of claim 2.

6. The toner of claim 5, further comprising a binder resin, the binder resin being at least one of a polyester resin, an acrylic resin and an epoxy resin.

7. The toner of claim 6, wherein a glass transition temperature of the binder resin is 40° C. or more and 70° C. or less and a weight average molecular weight of the binder resin is 10,000 or more and 300,000 or less.

8. The toner of claim 5, further comprising a release agent.

9. The toner of claim 8, wherein the release agent has a melting temperature of 30° C. or more and 120° C. or less.

10. A toner comprising:
a toner base particle including the spherical particle of claim 2 and a release agent; and
the spherical particle of claim 2 with which a surface of the toner base particle is covered.

11. A developer comprising the toner of claim 5.

12. A developer comprising the toner of claim 10.

13. A developing device for forming a toner image by developing a latent image formed on an image bearing member by use of the developer of claim 11.

14. A developing device for forming a toner image by developing a latent image formed on an image bearing member by use of the developer of claim 12.

15. An image forming apparatus comprising:
an image bearing member on which a latent image is to be formed;
a latent image forming section for forming a latent image on the image bearing member; and
the developing device of claim 13.

16. An image forming apparatus comprising:
an image bearing member on which a latent image is to be formed;
a latent image forming section for forming a latent image on the image bearing member; and
the developing device of claim 14.
